(19) United States
(12) Patent Application Publication
(10) Pub. No.: US 2024/0057190 A1
(43) Pub. Date: Feb. 15, 2024

(54) RESOURCE ASSOCIATION AND LINK RECOVERY FOR REPEATERS

(71) Applicant: Samsung Electronics Co., Ltd., Suwon-si (KR)

(72) Inventors: Ebrahim MolavianJazi, San Jose, CA (US); Marian Rudolf, Longueuil (CA); Aristides Papasakellariou, Houston, TX (US)

(21) Appl. No.: 18/365,820

(22) Filed: Aug. 4, 2023

Related U.S. Application Data
(60) Provisional application No. 63/397,293, filed on Aug. 11, 2022.
(60) Provisional application No. 63/422,371, filed on Nov. 3, 2022.
(60) Provisional application No. 63/465,698, filed on May 11, 2023.

(51) Int. Cl. H04W 76/19; H04W 16/28; H04W 76/20

(52) U.S. Cl. CPC H04W 76/19; H04W 16/28; H04W 76/20

(57) ABSTRACT

Methods and apparatuses for resource association and link recovery for repeaters in a wireless communication system. A method for a network-controlled repeater (NCR) includes receiving first information for time-domain resources and for corresponding beams for an access link and receiving or transmitting radio frequency (RF) signals on the access link using the beams over the corresponding time-domain resources prior to a link failure event. The method further includes determining the link failure event on a control link (C-link) and performing a link recovery procedure on the C-link. The method further includes suspending receiving or transmitting the RF signals on the access link using the beams over the corresponding time-domain resources during the link recovery procedure.

### CROSS-REFERENCE TO RELATED APPLICATIONS AND CLAIM OF PRIORITY

The present application claims priority to:
U.S. Provisional Patent Application No. 63/397,293, filed on Aug. 11, 2022;
U.S. Provisional Patent Application No. 63/422,371, filed on Nov. 3, 2022; and
U.S. Provisional Patent Application No. 63/465,698, filed on May 11, 2023. The contents of the above-identified patent documents are incorporated herein by reference.

### TECHNICAL FIELD

The present disclosure relates generally to wireless communication systems and, more specifically, the present disclosure relates to resource association and link recovery for repeaters in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a resource association and link recovery for repeaters in a wireless communication system.

In one embodiment, a method for a network-controlled repeater (NCR) is provided. The method includes receiving first information, by an NCR mobile termination (NCR-MT) entity, for time-domain resources and for corresponding beams for an access link of an NCR-forwarding (NCR-Fwd) entity and receiving or transmitting, by the NCR-Fwd entity, radio frequency (RF) signals on the access link using the beams over the corresponding time-domain resources prior to a link failure event. The method further includes determining, by the NCR-MT entity, the link failure event on a control link (C-link) of the NCR-MT entity and performing, by the NCR-MT entity, a link recovery procedure on the C-link. The method further includes suspending receiving or transmitting, by the NCR-Fwd entity, the RF signals on the access link using the beams over the corresponding time-domain resources during the link recovery procedure.

In another embodiment, an NCR is provided. The NCR includes a transceiver for an NCR-MT entity configured to receive first information for time-domain resources and for corresponding beams for an access link of an NCR-Fwd entity. The NCR further includes a transceiver for the NCR-Fwd entity that is operably coupled to the transceiver for the NCR-MT entity and configured to receive or transmit RF signals on the access link using the beams over the corresponding time-domain resources prior to a link failure event. The NCR further includes a processor for the NCR-MT entity, operably coupled to the transceiver for the NCR-MT entity and the transceiver for the NCR-Fwd entity. The processor is configured to determine the link failure event on a C-link of the NCR-MT entity and perform a link recovery procedure on the C-link. The transceiver for the NCR-Fwd entity is further configured to suspend receiving or transmitting the RF signals on the access link using the beams over the corresponding time-domain resources during the link recovery procedure.

In yet another embodiment, a base station is provided. The base station includes a transceiver configured to transmit, to a NCR-MT entity, first information for time-domain resources and for corresponding beams for an access link of a NCR-Fwd entity and transmit to or receive from the NCR-Fwd entity backhaul signals on a backhaul link of the NCR-Fwd entity associated with transmissions or receptions of RF signals on the access link using the beams over the corresponding time-domain resources prior to a link failure event. The base station further includes a processor, operably coupled to the transceiver, configured to determine a link failure event on a C-link of the NCR-MT entity and perform a link recovery procedure on the C-link. The transceiver is further configured to suspend transmitting or receiving the backhaul signals the backhaul link associated with transmissions or receptions of the RF signals on the access link using the beams over the corresponding time-domain resources during a link recovery procedure associated with the link failure event.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of a transmit receive point (TRP) according to embodiments of the present disclosure;

FIG. 3 illustrates an example of a user equipment (UE) according to embodiments of the present disclosure;

FIGS. 4 and 5 illustrate example of wireless transmit and receive paths according to this disclosure;

FIG. 6 illustrates an example of a user plane (UP) protocol architecture for the an NCR according to embodiments of the present disclosure;

FIG. 7 illustrates an example of a control plane (CP) protocol architecture for an NCR according to embodiments of the present disclosure;

FIG. 8 illustrates an example of a functional architecture for smart repeater (SR) or NCR according to embodiments of the present disclosure;

FIG. 9 illustrates an example of a functional architecture of an NCR according to embodiments of the present disclosure;

FIG. 10 illustrates a flowchart of procedure for a determination of ON or OFF state for NCR-Fwd based on radio link failure (RLF) or beam failure recovery (BFR) event for NCR-MT; and

FIG. 11 illustrates a flowchart of procedure for a determination of ON or OFF state or beam indication for NCR-Fwd during C-DRX or RRC_IDLE or RRC_INACTIVE state of NCR-MT according to embodiments of the present disclosure.

### DETAILED DESCRIPTION

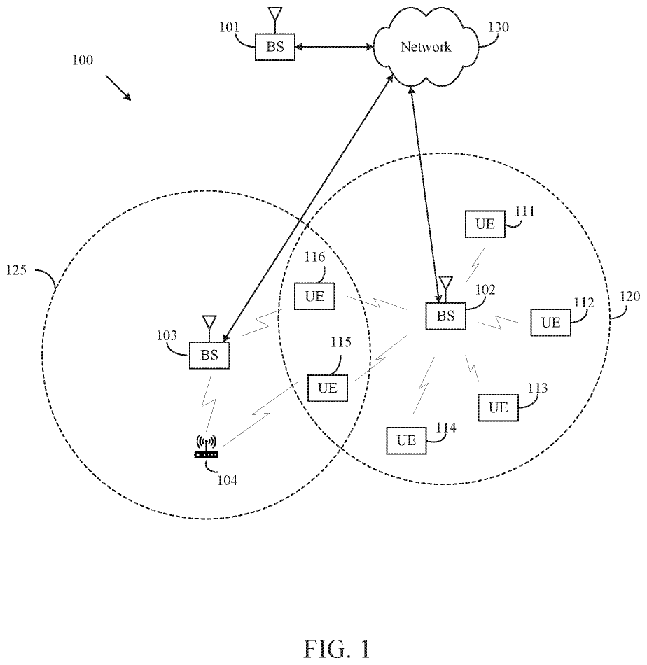

FIG. 1 through FIG. 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.3.0, “NR; Physical channels and modulation”; 3GPP TS 38.212 v17.3.0, “NR; Multiplexing and Channel coding”; 3GPP TS 38.213 v17.3.0, “NR; Physical Layer Procedures for Control”; 3GPP TS 38.214 v17.3.0, “NR; Physical Layer Procedures for Data”; 3GPP TS 38.215 Rel-17 v17.3.0, “NR; Physical layer measurements”; 3GPP TS 38.321 v17.2.0, “NR; Medium Access Control (MAC) protocol specification,” 3GPP TS 38.331 v17.2.0, “NR; Radio Resource Control (RRC) Protocol Specification”; 3GPP TS 38.300 Rel-17 v17.2.0, “NR; NR and NG-RAN Overall Description; Stage 2”; and 3GPP TR 38.867 Rel-18 V18.0.0, “Study on NR network-controlled repeaters; (Release 18)”.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNB s 101-103 may communicate with each other and with the UEs 111-116 using 5G/NR, long term evolution (LTE), long term evolution-advanced (LTE-A), WiMAX, WiFi, or other wireless communication techniques. A relay node 104 relays signals between gNB 103 and UE 115. A relay node can be an integrated access and backhaul node (IAB) or NCR.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, a relay node 104 includes circuitry, programing, or a combination thereof, to support a resource association and link recovery for repeaters in a wireless communication system. In certain embodiments, one or more of the gNBs 101-103 includes circuitry, programing, or a combination thereof, to support resource association and link recovery for repeaters in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

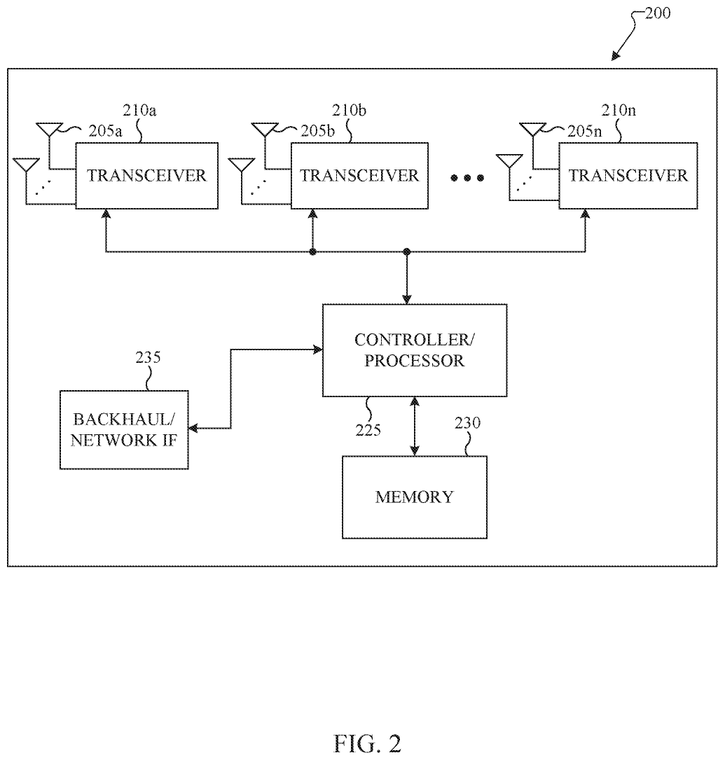

FIG. 2 illustrates an example TRP 200 according to embodiments of the present disclosure. For example, the TRP 200 any be a base station, such as gNB 101-103, or may be an NCR or SR, such as the relay node 104 in FIG. 1. The embodiment of the TRP 200 illustrated in FIG. 2 is for illustration only. However, TRPs come in a wide variety of configurations, and FIG. 2 does not limit the scope of this disclosure to any particular implementation of a TRP.

As shown in FIG. 2, the TRP 200 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs or gNBs in the network 100. In various embodiments, certain of the transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals. For example, in embodiments where the TRP is a repeater, one or more of the transceivers 210 may be used for an NCR-RU entity or NCR-Fwd entity as a DL connection for signaling over an access link with a UE and/or over a backhaul link with a gNB. In these examples, the associated one(s) of the transceivers 210 for the NCR-RU entity or NCR-Fwd entity may not covert the incoming RF signal to IF or a baseband signal but rather amplify the incoming RF signal and forward or relay the amplified signal, without any down conversion to IF or baseband. In another example, in embodiments where the TRP is a repeater, one or more of the transceivers 210 may be used for an NCR-MT entity as a DL or UL connection for control signaling over a control link (C-link) with a gNB.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the TRP 200. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the TRP 200 by the controller/processor 225.

The controller/processor 225 is also capable of executing programs and other processes resident in the memory 230, processes to support resource association and link recovery for repeaters in accordance with various embodiments of the present disclosure. For The controller/processor 225 can move data into or out of the memory 230 as required by an executing process.

The controller/processor 225 is also coupled to the backhaul or network interface 235. The backhaul or network interface 235 allows the TRP 200 to communicate with other devices or systems over a backhaul connection or over a network. The interface 235 could support communications over any suitable wired or wireless connection(s). For example, when the TRP 200 is implemented as part of a cellular communication system (such as one supporting 5G/NR, LTE, or LTE-A), the interface 235 could allow the TRP 200 to communicate with other gNBs over a wired or wireless backhaul connection, for example, using a transceiver, such as described above with regard to transceivers 210. For example, in embodiments where the TRP is a repeater, the interface 235 may be used for an NCR-RU or NCR-Fwd entity as a backhaul connection with a gNB over a backhaul link for control signaling and/or data to be transmitted to and/or received from a UE. When the TRP 200 is implemented as an access point, the interface 235 could allow the TRP 200 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

In various embodiments, the TRP 200 may be utilized as an NCR or SR. For example, the TRP 200 may communicate with a base station 102 via a wireless backhaul over interface 235 via a NCT-MT entity for control information and may communicate via transceivers 210 with the a UE 116 to communicate data information via an NCR-Fwd entity as described in greater detail below.

Although FIG. 2 illustrates one example of TRP 200, various changes may be made to FIG. 2. For example, the TRP 200 could include any number of each component shown in FIG. 2. Also, various components in FIG. 2 could be combined, further subdivided, or omitted and additional components could be added according to particular needs.

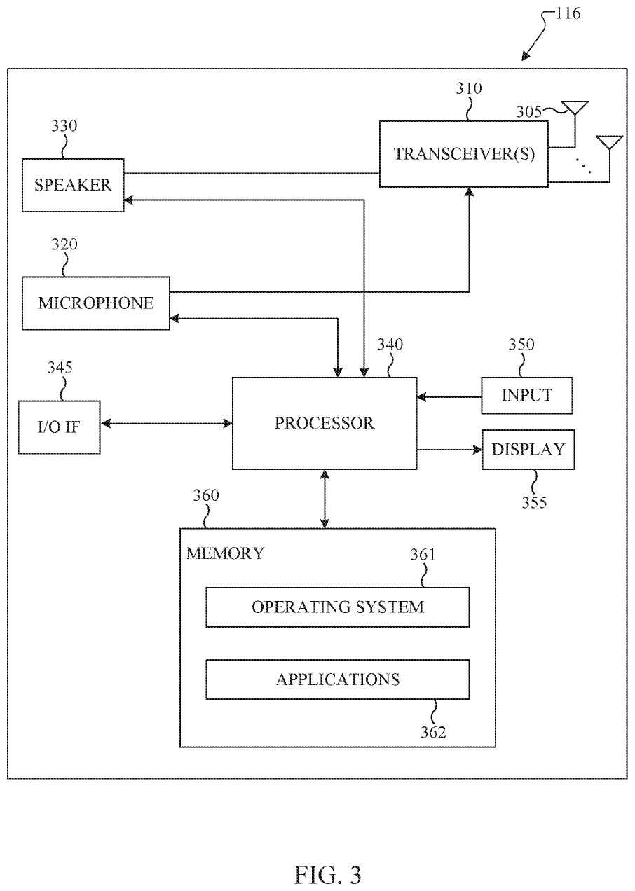

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 can move data into or out of the memory 360 as required by an executing process. In some embodiments, the processor 340 is configured to execute the applications 362 based on the OS 361 or in response to signals received from gNB s or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355, which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

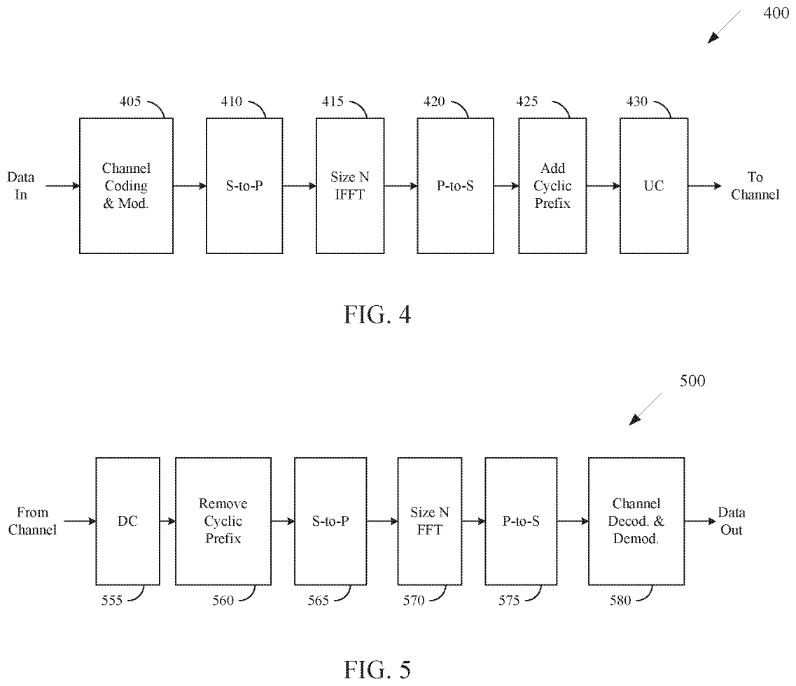

FIG. 4 and FIG. 5 illustrate example wireless transmit and receive paths according to this disclosure. In the following description, a transmit path 400 may be described as being implemented in a gNB or TRP (such as the gNB 102 or TRP 200), while a receive path 500 may be described as being implemented in a UE (such as a UE 116). However, it may be understood that the receive path 500 can be implemented in a gNB or TRP and that the transmit path 400 can be implemented in a UE. In some embodiments, the receive path 500 is configured to support a resource association and link recovery for repeaters in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNB s 101-103 or the TRP 200 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 or the TRP 200 and may implement the receive path 500 for receiving in the downlink from the gNBs 101-103 or the TRP 200.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

The present disclosure relates to a pre-5th-generation (5G) or 5G or beyond 5G communication system to be provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 5G Advanced, 6G, and so on), IEEE standards (such as 802.16 WiMAX and 802.11 Wi-Fi and so on), and so forth.

There is a need for interference management for an NCR, also known as a SR, so that the gNB can control in which time/frequency resources the NCR is performing amplify-and-forward operation. In particular, the gNB may be able to switch off the NCR when deemed necessary, in order to avoid interference to serving cells or neighbor cells.

There is another need to determine an association between the time/frequency/spatial domain resources and an on-off indication from the gNB for an NCR-Fwd, also referred to as NCR-RU.

The present disclosure provides methods and apparatus for on-off information indication for SRs, also known as NCR.

In general, the embodiments apply to any deployments, verticals, or scenarios including FR1, FR2 or in FR1+FR2, with eMBB, URLLC and IIoT and extended reality (XR), mMTC and IoT, with sidelink/V2X communications, with multi-TRP/beam/panel, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multi-cast broadcast services (MBS), and so on.

In one embodiment, when an NCR is provided or determines on-off information for a symbol or slot, an NCR can be provided information of beams or spatial filters or associated reference signals (RSs), such as SSB indexes, with respect to which the NCR-Fwd is in the ON or OFF state. Such behavior can be beneficial for interference management, for example, when the NCR is operating with a subset of beams or associated RS s, such as a subset of SSB indexes, so that the NCR-Fwd does not amplify-and-forward RF signals associated with undesired spatial directions.

In one embodiment, when an NCR determines or is provided on-off information for a symbol or slot, an NCR can be provided information of a set of desired frequency resources, such as a set of RBs, with respect to which the NCR-Fwd is in the ON or OFF state. Accordingly, the NCR-Fwd can be in ON state only for a first set of RBs in a symbol or slot, and in OFF state for other RBs in the same symbol or slot. Such operation can be beneficial for interference management, for example, when the gNB and/or the NCR have information that a transmission or reception in a symbol or slot is confined to certain RBs, so NCR-Fwd is turned off in other RBs, so that noise amplification in those RBs are avoided. The operation can be subject to NCR capability.

In one embodiment, the ON-OFF state of an NCR can be for a certain link direction, such as single directional, and not bi-directional. Accordingly, the NCR can determine or can be provided link direction information, such as downlink or uplink, associated with an on-off indication information. For example, the NCR can determine or can be indicated to be in ON state only for downlink direction and not for uplink direction (or vice versa). Such operation can be beneficial for interference management, when the gNB and/or NCR have information that transmissions or reception in some symbols/slots are only in a certain link direction. Such behavior can be applied, for example, for NCR operation in an FDD frequency band such as in FR1, or for operation in flexible symbols of TDD DL/UL configuration of a TDD band such as in FR2.

In one embodiment, when an NCR determines or is provided with a TDD DL/UL configuration that includes flexible symbols or slot, the UE determines a DL or UL link direction for the flexible symbol/slot based on an indication provided for beamforming information indication. Accordingly, the NCR can receive a joint indication for both beamforming information, such as access/backhaul link beam indication, and the DL/UL link direction. The indication can be provided, for example, by L1/L2 signaling such as a DCI format or MAC-CE command. When such link direction is not provided, the NCR-Fwd can apply a predetermined or (pre)configured reference link direction, such as DL direction for the AF operation. The operation can be subject to NCR capability.

In the present disclosure, the term “configuration” or “higher layer configuration” and variations thereof (such as “configured” and so on) are used to refer to one or more of: a system information signaling such as by a MIB or a SIB (such as SIB1), a common or cell-specific higher layer/RRC signaling, or a dedicated or UE-specific or BWP-specific higher layer/RRC signaling.

The synchronization signal and PBCH block (SSB) includes primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e., using different beams, spanning the coverage area of a cell).

Within the frequency span of a carrier, multiple SSBs can be transmitted. The PCIs of SSBs transmitted in different frequency locations may not be unique, i.e., different SSBs in the frequency domain can have different PCIs. However, when an SSB is associated with an RMSI, the SSB is referred to as a cell-defining SSB (CD-SSB). A PCell is always associated to a CD-SSB located on the synchronization raster.

Polar coding is used for PBCH. The UE may assume a band-specific sub-carrier spacing for the SSB unless a network has configured the UE to assume a different sub-carrier spacing. PBCH symbols carry its own frequency-multiplexed DMRS. QPSK modulation is used for PBCH.

Integrated access and backhaul (IAB) enables wireless relaying in NG-RAN. The relaying node, referred to as IAB-node, supports access and backhauling via NR. The terminating node of NR backhauling on network side is referred to as the IAB-donor, which represents a gNB with additional functionality to support IAB. Backhauling can occur via a single or via multiple hops.

The IAB-node supports gNB-DU functionality to terminate the NR access interface to UEs and next-hop IAB-nodes, and to terminate the F1 protocol to the gNB-CU functionality on the IAB-donor. The gNB-DU functionality on the IAB-node is also referred to as IAB-DU.

In addition to the gNB-DU functionality, the IAB-node also supports a subset of the UE functionality referred to as IAB-MT, which includes, e.g., physical layer, layer-2, RRC and NAS functionality to connect to the gNB-DU of another IAB-node or the IAB-donor, to connect to the gNB-CU on the IAB-donor, and to the core network.

The IAB-node can access the network using either SA mode or EN-DC. In EN-DC, the IAB-node connects via E-UTRA to a MeNB, and the IAB-donor terminates X2-C as SgNB.

All IAB-nodes that are connected to an IAB-donor via one or multiple hops form a directed acyclic graph (DAG) topology with the IAB-donor as its root. In this DAG topology, the neighbor node of the IAB-DU or the IAB-donor-DU is referred to as child node and the neighbor node of the IAB-MT is referred to as parent node. The direction toward the child node is referred to as downstream while the direction toward the parent node is referred to as upstream. The IAB -donor performs centralized resource, topology and route management for the IAB topology.

F1-U and F1-C use an IP transport layer between IAB-DU and IAB-donor-CU. F-U and F1-C need to be security-protected.

On the wireless backhaul, the IP layer is carried over the backhaul adaptation protocol (BAP) sublayer, which enables routing over multiple hops. The IP layer can also be used for non-F1 traffic, such as OAM traffic.

On each backhaul link, the BAP PDUs are carried by BH RLC channels. Multiple BH RLC channels can be configured on each BH link to allow traffic prioritization and QoS enforcement. The BH-RLC-channel mapping for BAP PDUs is performed by the BAP entities on each IAB-node and the IAB-donor-DU.

The IAB-MT further establishes SRBs (carrying RRC and NAS) with the IAB-donor-CU. For IAB-nodes operating in EN-DC, the IAB-MT establishes one or more DRBs with the eNB and one or more DRBs with the IAB-donor-CU, which can be used, e.g., to carry OAM traffic. For SA mode, the establishment of DRBs is optional. These SRBs and DRBs are transported between the IAB-MT and its parent node over Uu access channel(s).

Coverage is a fundamental aspect of cellular network deployments. Cellular operators rely on different types of network nodes to offer blanket coverage in their deployments. Deployment of regular full-stack cells, e.g., cells served by a gNB type base stations usually based results in expensive implementation, high cost for equipment and backhaul connectivity. Their deployment is subjected to a variety of constraints such as expensive site leases. While this is the predominant deployment type encountered in practice, it is not always preferred cost-wise. As a result, other types of network nodes have been considered to increase cellular operators' economic flexibility for their network deployments.

For example, IAB was introduced in 5G NR Rel-16 and enhanced in Rel-17 as a new type of network node not requiring a wired backhaul. IAB nodes can be considered full-stack cells similar to gNBs. The IAB node is a new type of relay node building over the front-haul architecture and constituting a node with a dual role including an IAB distributed unit (DU) component making it possible to appear as a regular cell to the UEs which the DU serves, and an IAB MT component inheriting many properties of a regular UE whereby the IAB node connects to its donor parent node(s) or a gNB. The IAB node is based on a Layer 2 architecture with end-to-end PDCP layer from the donor IAB node to the UE for control plane (CP) and user plane (UP).

IAB nodes can also be classified as re-generative relays. Every packet traversing the link between the donor node and the IAB -MT component of the IAB node, i.e., the backhaul-link, may be properly decoded and re-encoded by the IAB node for further transmission to the UE on the access link. The first version of IAB in Rel-16 NR assumes half duplex operation in TDM between access and backhaul links for transmission and reception by the IAB node but includes features for forward compatibility towards evolving IAB using full duplex operation. Rel-17 NR further enhances IAB operation with better support of full duplex implementations of IAB nodes.

Another type of network node is the RF repeater which amplifies-and-forwards any signal that the repeater receives. RF repeaters have seen a wide range of deployments in 2G GSM/(E)GPRS, 3G WCDMA/HSPA and 4G LTE/LTE-A to supplement the coverage provided by regular full-stack cells. RF repeaters constitute the simplest and most cost-effective way to improve network coverage. The main advantages of RF repeaters are their low -cost, their ease of deployment and the fact that they do not much increase latency. The main disadvantage is that they amplify both desired signal(s) and (undesired) noise and hence, often contribute to an increase of interference levels observed at system level. Within RF repeaters, there are different categories depending on the power characteristics and the amount of spectrum that they are configured to amplify, e.g., single band, multi-band, etc. RF repeaters are considered non-regenerative type of relay nodes. RF repeaters are typically full-duplex nodes and they do not differentiate between UL and DL transmissions or receptions. LTE specifies RF repeater requirements in 36.106. Their use is limited to LTE FDD bands.

In Rel-17 NR, RF and EMC requirements in FR1 and FR2 for RF repeaters using NR were introduced. As NR often uses higher frequencies, e.g., 3-4 GHz in FR1 and above 24 GHz for FR2, propagation conditions are degraded when compared to lower frequencies in use by LTE. This exacerbates the coverage challenges for NR. More densification of cells becomes necessary. massive MIMO operation in FR1, analog beamforming in FR2 and multi-beam operation with associated beam management in FR1 and FR2 are integral part of the NR design to cope with the challenging propagation conditions of these higher frequencies. Note that these NR frequency bands are TDD.

In consequence, simultaneous or bi-directional amplify-and-forward as employed by traditional RF repeaters is not always necessary (unlike in the FDD LTE case) and can therefore be avoided. This much reduces the noise pollution problem of regular RF repeaters which amplify both (undesired) noise and desired signal(s). Beamformed transmissions and receptions to/from individual NR users are a fundamental feature and inherent to NR operation. However, the use of a simple RF repeater operating in the NR network implies that the prerequisite beamforming gains for NR operation to provide coverage are not available when relaying the NR transmissions and receptions. While a conventional RF repeater presents a very cost-effective means of extending network coverage, the repeater has limitations when considering NR.

Therefore, a new type of network node, somewhere in-between RF repeaters and IAB nodes is a compelling proposition to try to leverage the main advantages of both. That new type of network node, i.e., a SR or NCR can make use of some side control information (SCI) or NCR control information (NCI) to enable a more intelligent amplify-and-forward operation in a system with TDD access and multi-beam operation. SCI allows an NCR or SR to perform the amplify- and-forward operation in a more efficient manner. Potential benefits include mitigation of unnecessary noise amplification, transmissions and receptions with better spatial directivity, and much simplified network integration. In the C-plane, an NCR may be provided or configured by the gNB with information on semi-static and/or dynamic downlink/uplink configuration, adaptive transmitter/receiver spatial beamforming, Tx on/off status, etc. In the user plane (U-plane), the NCR is still non-regenerative, e.g., the NCR employs amplify-and-forward to relay the actual UE signals from/to the gNB. NCI transmission and requires only low capacity for the control backhaul between the donor cell(s), e.g., gNB and the NCR. As a result, the low-complexity and low-cost properties of RF repeaters are mostly preserved while a degree of network configurability and control is enabled similar to eIAB nodes.

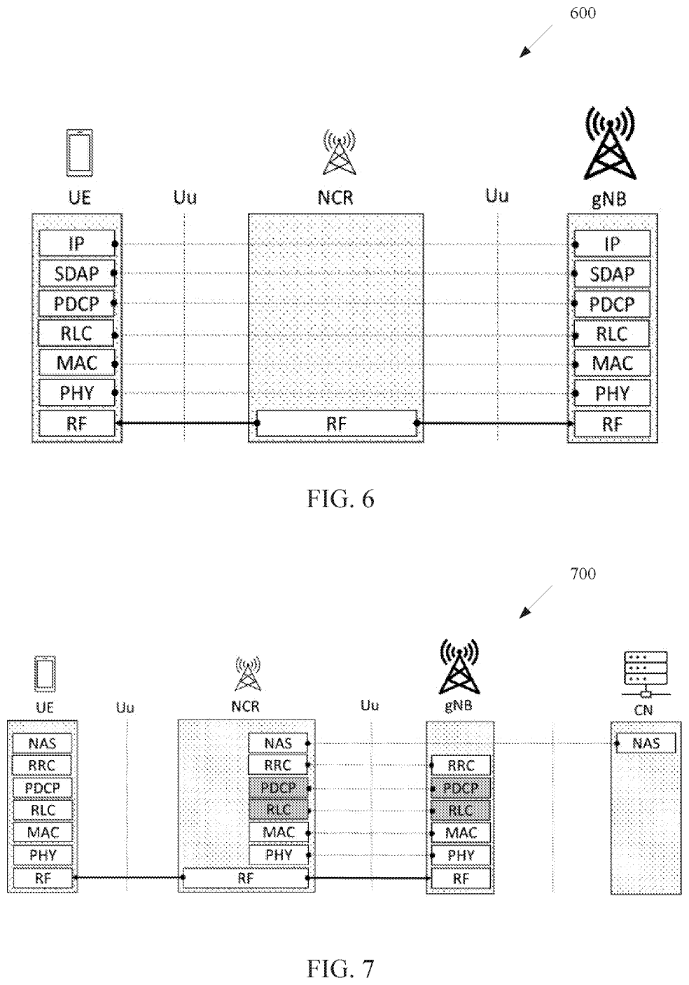

FIGS. 6 to 9 show examples for the functional and protocol architectures of an NCR. FIG. 6 illustrates an example of a UP protocol architecture for the NCR 600 according to embodiments of the present disclosure. An embodiment of the UP protocol architecture for the NCR 600 shown in FIG. 6 is for illustration only.

In FIG. 6, the NCR receives the incoming RF signal from the gNB (or the UE) at its ingress antenna port, then amplifies-and-forwards the RF signal to its egress antenna port to the UE (or gNB). Note that similar to a conventional RF repeater, the amplified-and-forwarded signal traverses the RF path, e.g., is the signal is processed in analog domain. In the control plane (FIG. 7), e.g., when transmitting downlink NCR control information (DL NCI) from gNB to the SR, or when transmitting uplink NCR control information (UL NCI) from the NCR to the gNB, the signal processing by the NCR differs.

For transmission of DL NCI, the gNB can use one or a combination of signaling options. DL NCI can be transmitted in L1, e.g., by DCI or in any DL control channel, in L2 MAC, e.g., by MAC CE(s) or as part of any DL data channel, in L2 RRC, e.g., by RRC signaling messages and/or IEs. Without loss of generality and illustration purposes, it may be assumed that the NCR converts part of the incoming (DL) RF signal from the gNB to digital domain to determine presence and further process the received signaling contents of DL NCI. For transmission of UL NCI to the gNB, it may be assumed that the NCR receives the incoming RF signal from the UE at its ingress antenna port, then amplifies-and-forwards the RF signal while adding the UL NCI following its conversion from digital signaling processing to analog domain for transmission at the egress antenna port as illustrated in FIG. 6.

For transmission of UL NCI, the NCR can use one or a combination of signaling options. UL NCI can be transmitted in L1, e.g., by an UL control or data channel, in L2 MAC, e.g., by MAC CE(s) or as part of any UL data channel, in L2 RRC, e.g., by RRC signaling messages and/or IEs. Note that the NCR may also be configured or provisioned or receive or transmit signaling messages using non-access stratum (NAS) protocol messages, e.g., CM, SM, etc., and/or by O&M signaling. Furthermore, transmission and reception of DL and UL NCI may occur using in-band signaling, e.g., using the same frequency band/channel as the amplified-and-forwarded UE signal(s), or may occur using out-of-band signaling, e.g., NCI is transmitted and received using a different band, channel or frequency range than the amplified-and-forwarded UE signal(s).

FIG. 7 illustrates an example of a CP protocol architecture 700 for an NCR according to embodiments of the present disclosure. An embodiment of the CP protocol architecture 700 for the NCR shown in FIG. 7 is for illustration only.

Various embodiments, methods, and examples described in the present disclosure can apply beyond NCR/SR nodes to other nodes with a repeater/relay-like functionality in a wireless network, such as reconfigurable intelligent surfaces (RIS) and so on.

In the present disclosure, when an NCR-Fwd is in ON state, the NCR-Fwd performs the amplify-and-forward operation, for example, by applying a certain power amplification gain or with a certain output power level greater than or equal to an “on” threshold value, which can be predetermined or (pre)configured or indicated by higher layer configuration or L1/L2 signaling. When the NCR-Fwd is in OFF state, the NCR-Fwd does not perform the amplify-and-forward operation, for example, applies a power amplification gain or with a certain output power level that is less than or equal to an “off” threshold, which can be also predetermined or (pre)configured or indicated by higher layer configuration or L1/L2 signaling.

In one embodiment, when an NCR is provided or determines on-off information for a symbol or slot, an NCR can be provided information of beams or spatial filters or associated RSs, such as SSB indexes, with respect to which the NCR-Fwd is in the ON or OFF state. Such behavior can be beneficial for interference management, for example, when the NCR is operating with a subset of beams or associated RSs, such as a subset of SSB indexes, so that the NCR-Fwd does not amplify-and-forward RF signals associated with undesired spatial directions.

In one example, when an NCR-Fwd can identify to be in ON state during cell-specific transmissions or receptions, such as SSB or PRACH or monitoring occasions (MOs) corresponding to PDCCH for system information or paging, and so on, the NCR-MT can receive indication of a set/subset of desired beams or spatial filters or associated RSs, such as a set/subset of desired SSB indexes, for which the NCR-Fwd is in ON state. Herein, identification of the ON state can be based on predetermined rules in the specifications for system operation or (pre)configuration by higher layer configuration such as system information, for example cell-specific SI (SIB1 or OSI) or an NCR-specific SIBx (x>1) or by common or dedicated RRC signaling or O&M signaling, or by L1/L2 indication such as a DCI format or a MAC-CE command. Herein, indication of the set/subset of desired beams, such as SSB indexes, can be by higher layer configuration or by L1/L2 signaling.

For example, when the NCR determines that the NCR-Fwd is (pre)configured to perform amplify-and-forward (AF) corresponding to a first set/subset of SSB indexes, the NCR-Fwd is expected to be on during symbols/slots associated with the first set/subset of SSB indexes, and off during other symbols/slots associated with the any SSB index not included in the first set/subset of SSB indexes. In addition, the NCR-Fwd is expected to apply a spatial filter in a symbol/slots that corresponds to the SSB index. For example, the NCR-Fwd applies a first beam or spatial filter for symbols/slots associated with SSB #0 and applies a second beam or spatial filter for symbols/slots associated with SSB #1.

For example, higher layer configuration such as SIB1 can indicate a set of SSB indexes configured for the cell, such as SSB indexes {#0, #1, . . . , #63} for example in FR2, and the NCR-Fwd performs AF operation on SSB indexes {#0, #1, #2, #3} only. In such case, the NCR-Fwd is in ON state only during symbols/slots associated with SSB indexes {#0, #1, #2, #3 }, and is OFF state in during symbols/slots associated with other SSB indexes {#4, #5, . . . , #63}. In addition, for symbols/slots associated with SSB indexes {#0, #1, #2, #3}, the NCR-Fwd applies the corresponding spatial filters, so that interference from other spatial directions are avoided.

Herein, cell refers to a cell, such as PCell, configured for NCR-MT, or a cell from the set of cells/carriers or passbands for which the NCR-Fwd performs the AF operation. In one example, when multiple cells or passbands are applicable to NCR-MT operation, in one example, a same set of beams or SSB indexes applies to on-off indication for the multiple cells or passbands. In another example, the NCR can determine separate beams such as separate SSB indexes that are applied for on-off indication for each of the multiple cells or passbands.

In one example, the NCR determines a set of desired SSB indexes associated with on-off indication by explicit signaling such as by higher layer configuration or by L1/L2 signaling. In another example, the NCR determines the set of desired SSB indexes associated with on-off indication based on other information provided to the NCR, such as a set of SSB indexes configured or indicated for the access/backhaul beam indication for the purpose of AF operation by the NCR-Fwd, so additional signaling may not be necessary. In another example, a combination can be considered, wherein the NCR can determine the set of desired SSB indexes associated with on-off indication to be at least the SSB indexes provided as part of beamforming information, and the NCR can be provided additional SSB indexes by explicit signaling. For example, the NCR operates with SSB indexes {#0, #1, #2, #3}, and the gNB can indicates additional SSB indexes such as “neighbor” SSB indexes {#4, #63}, for example, in order to determine the UE activity in areas in the proximity of the NCR coverage areas. Therefore, the set of desired SSB indexes can be {#0, #1, #2, #3, #4, #63}, for which the NCR-Fwd is in ON state, and the is in OFF state for other SSB indexes {#5, #6, . . . , #62}.

In one example, similar on-off association with SSB indexes can be applied to other cell-specific transmissions or receptions. For example, the NCR-Fwd is in ON state for any RACH occasion (RO) that is associated with the desired SSB indexes, and is in OFF state during other ROs associated with SSB indexes not included in the set of desired SSB indexes. For example, the NCR-Fwd is in ON state during PDCCH monitoring occasions (MOs) for reception of system information or paging, and so on, (for example, based on CORESET #0 and Search Space set #0 or other related configuration) that are associated with the set of desired SSB indexes, and is in OFF state during other PDCCH MOs associated with SSB indexes not included in the set of desired SSB indexes. The examples can be generalized to any uplink or downlink transmission or reception, such as SPS PDSCH or configured-grant PUSCH (CG-PUSCH) or other PDSCH/PDCCH or PUSCH/PUCCH, that are associated with the set of desired SSB indexes, wherein the NCR can be predetermine or (pre)configured or indicated an association with SSB indexes.

In one example, the method can be extended to other RSs, such as non-cell defining SSB (NCD-SSB) or CSI-RS resources. For example, the RSs can be shared among a number of UEs, such as UEs served by the NCR. The NCR can be provided with applicable configuration information of such RSs, for example, time/frequency resource allocation of the RSs or quasi-co-location (QCL) properties of the RS, such as spatial domain QCL (referred to as QCL type-D). Accordingly, the NCR can be in ON states during a set of desired NCD-SSB indexes or a set of desired CSI-RS resources, from the configured NCD-SSBs or CSI-RS resource, and the NCR is in OFF state during symbols/slots associated with other NCD-SSBs or CSI-RS resource not included in the set of desired NCD-SSB indexes or a set of desired CSI-RS resources. Similar holds for uplink or downlink transmission or reception associated with such RSs.

In one example, the NCR can receive higher layer reconfiguration message or L1/L2 signaling that updates the information of the set of desired SSB indexes (or for other RSs, as described above). Accordingly, the NCR-MT determines the beam-specific on-off indication based on the updated information.

In one example, an indication for beam-specific on-off can include a certain value, such as “−1,” that indicates the NCR-Fwd is in ON states during symbols/slots associated with all beams or spatial filters, such as all SSB indexes. In another example, such behavior is considered to be the default NCR behavior, so when the NCR is not provided with any higher layer configuration or L1/L2 signaling for beam-specific on-off indication, the NCR determines that NCR-Fwd is in ON state during symbols/slots associated with all beams or spatial filters, such as all SSB indexes, without need for additional signaling.

In one example, the method can be extended to the case wherein two different beams or spatial filters corresponding to two different RSs are associated with a same symbol or slot, and the UE can be in ON state with respect to a first beam/RS and can be in OFF state with respect to the second beam/RS.

In one embodiment, when an NCR determines or is provided on-off information for a symbol or slot, an NCR can be provided information of a set of desired frequency resources, such as a set of RBs, with respect to which the NCR-Fwd is in the ON or OFF state. Accordingly, the NCR-Fwd can be in ON state only for a first set of RBs in a symbol or slot, and in OFF state for other RBs in the same symbol or slot. Such operation can be beneficial for interference management, for example, when the gNB and/or the NCR have information that a transmission or reception in a symbol or slot is confined to certain RBs, so NCR-Fwd is turned off in other RBs, so that noise amplification in those RBs are avoided. The operation can be subject to NCR capability.

In one embodiment, the NCR can determine or can be provided time-domain resources, such as a list or pattern of symbols or slots, during which the NCR-Fwd can be in ON state, and the NCR can determine or can be provided frequency domain resources, such as a list or pattern of REs or RBs, corresponding to the time-domain resources in which the NCR-Fwd is in ON state. For example, the NCR-Fwd is in ON state in the list or pattern of REs or RBs corresponding to the list or pattern of symbols or slots. For example, the NCR is in OFF state in any symbols or slot that is not included in the list or pattern of symbols or slots, and is also in OFF state in any REs or RBs not included in the list or pattern of REs of RBs even when corresponding to the list or pattern of symbols or slots.

In one example, the NCR can be predetermined or (pre)configured with a number of RB groups or RB sets groups, such as RB groups of size N RBs, for example N=4 or 8 or 16 or 64 RBs. The NCR pass bands can be grouped, for example to M such RB groups, each of size N RBs. The NCR-Fwd can be indicated, for a symbol or slot, to be in ON state for first RB groups and in OFF state for second RB groups, from the number of M RB groups. For example, the NCR pass band can be grouped in M=48 RB groups, and the NCR-Fwd can be indicated to be in ON state in RB groups {#10, #11, . . . , #27} for a given symbol/slot #10. Accordingly, the NCR-Fwd is in OFF state for symbol/slot #10 in RB groups {#0, #1, . . . , #9, #28, #29, . . . , #47}. For example, the NCR-Fwd can be in ON state in first RB groups in a first symbol/slot, and can be in OFF state in a second RB group in a second symbol/slot.

In one example, the NCR-MT receives information of which RB groups are on and which RB groups are off using higher layer signaling. In another example, the NCR-MT receives information of the RB groups and their association with the ON-OFF states using L1/L2 signaling. For example, the UE determines or receives information of the list or pattern of symbols/slot with ON state using higher layer configuration, and receives information of the RB groups with ON state using L1/L2 signaling such as a MAC-CE command or a DCI format. In another example, the on-off association information for both time and frequency domain is provided by L1/L2 signaling such as by a MAC CE command.

In one example, when the NCR determines ON state for different RB groups in a symbol or slot, different RB groups can be associated with different DL/UL link direction or different DL/UL TDD configuration. For example, the NCR can be indicated to be on for RB set groups #0 and #5, wherein the NCR-Fwd operates in DL direction for RB set group #0 and operates in UL direction for RB set group #5. In one example, the NCR can determine the link direction corresponding to different RB set groups, for example, based on the frequency location of the RB set groups. For example, the UE can be configured to operate in UL direction for first RB sets groups, such as RB set groups {#10, #11, #37}, and to operate in DL direction for second RB sets groups, such as RB set groups {#0, #1, . . . , #8, #9, #38, #39, . . . , #47}, for a set of symbols or slots. When the NCR-Fwd is indicated, for a symbol or slot from the set of symbols or slot, to be in ON state for a first RB set group, e.g., #20, from the first RB set groups, and also for a second RB set group, e.g., #6, from the second RB set groups, the NCR determines that the NCR-Fwd operates in UL direction for the first RB set group, e.g., #20, and operates in the DL direction for the second RB set group, e.g., #6. Such operation can be beneficial, for example, for any-division-duplex (XDD) operation.

Such operation can be extended to operation with multiple cells/carriers or multiple pass bands, such as for an NCR operating with multiple pass bands.

In one embodiment, the ON-OFF state of an NCR can be for a certain link direction, such as single directional, and not bi-directional. Accordingly, the NCR can determine or can be provided link direction information, such as downlink or uplink, associated with an on-off indication information. For example, the NCR can determine or can be indicated to be in ON state only for downlink direction and not for uplink direction (or vice versa). Such operation can be beneficial for interference management, when the gNB and/or NCR have information that transmissions or reception in some symbols/slots are only in a certain link direction. Such behavior can be applied, for example, for NCR operation in an FDD frequency band such as in FR1, or for operation in flexible symbols of TDD DL/UL configuration of a TDD band such as in FR2.

In one example, the NCR can determine a link direction during on slots/symbols based on the TDD DL/UL configuration, such as a cell-specific TDD DL/UL configuration or NCR-specific TDD DL/UL configuration, so additional signaling may not be needed. In another example, additional signaling for link direction during on slots/symbols can be applicable when the slots/symbols overlap or coincide with flexible slots/symbols provided by a TDD DL/UL configuration. Therefore, gNB indication such as L1/L2 signaling for on indication can additionally include the link direction (and possibly the beamforming information). In another example, such as for operation in an FDD band, a TDD DL/UL configuration may not be applicable, so link direction information may be necessary for any symbol/slot for which the NCR is configured or indicated to be in ON state, otherwise the NCR may be in on in both DL and UL directions for a symbol or slot.

In one example, when a repeater is used for AF operation of broadcast traffic, the RF signals may be mostly in DL direction, so NCR can determine or can be indicated to operate only in DL direction.

In one example, the NCR is used for assisting the radio access network (RAN) or the CORE network with certain use-cases or purposes, such as for positioning, in which case the NCR may be mostly used to AF positioning-related RS s, such as DL positioning reference signal (DL PRS). Therefore, the NCR can determine or can be indicated to operate only in DL direction.

In one example, the NCR may be used to support UE coverage in FR2 for DL traffic reception purposes. For example, the UE may already have an UL and DL connection to the gNB in FR1 without NCR assistance. In such a case, the NCR can operate in DL direction only.

In one embodiment, when an NCR determines or is provided with a TDD DL/UL configuration that includes flexible symbols or slot, the UE determines a DL or UL link direction for the flexible symbol/slot based on an indication provided for beamforming information indication. Accordingly, the NCR can receive a joint indication for both beamforming information, such as access/backhaul link beam indication, and the DL/UL link direction. The indication can be provided, for example, by L1/L2 signaling such as a DCI format or MAC-CE command. When such link direction is not provided, the NCR-Fwd can apply a predetermined or (pre)configured reference link direction, such as DL direction for the AF operation. The operation can be subject to NCR capability.

Herein, the TDD DL/UL configuration can be a cell-specific TDD DL/UL configuration, for example, provided by system information, or can be an NCR-specific TDD DL/UL configuration, provided by NCR-specific system information or by dedicated higher layer signaling. In one example, the NCR-specific TDD DL/UL configuration can be based on the UE-specific TDD DL/UL configuration of UEs served by the UEs, such as a union or intersection or other combination of such TDD configurations.

In one example, when a beamforming indication such as an L1/L2 signaling for access/backhaul link beam indication corresponds to a flexible symbol or slot, the L1/L2 signaling can include, in addition to the access/backhaul link beam indication information, a DL or UL link direction information as well. Accordingly, the UE determines to be in ON state for such flexible symbol and to operate with the indicated beam and in the indicated link direction. Similar methods can be used for joint indication of power control information and DL/UL link information for a flexible symbol or slot. Similar methods can be used for joint indication of beamforming information, and power control information and DL/UL link direction for a flexible symbol.

In one example, the NCR receives such indication at least an “application” time offset before the flexible symbol or slot, so that the NCR has sufficient time to process the signaling and to switch the beam or power or DL/UL link direction, if necessary. For example, the NCR is not expected to apply the indication for the flexible symbol or slot (for example, can go to OFF state) if the NCR receives the indication described above later than the minimum application time offset before the flexible symbol or slot.

In another example, when the NCR does not receive DL/UL link direction information for a flexible symbol or slot, the NCR applies a predetermined or (pre)configured reference link direction, such as DL. For example, when the NCR does not receive beamforming information or power control information for a flexible symbol or slot, the NCR applies a predetermined or (pre)configured reference beam (such as an SSB beam with smallest beam index) or a predetermined or (pre)configured reference power setting (such as maximum amplification gain). In one example, when the NCR does not receive any indication from the gNB regarding any of the NCR-Fwd operation parameters, the NCR determines to be in OFF state in that flexible symbol or slot.

Such behavior can be beneficial, for example, when flexible symbols are used by the gNB to schedule downlink or uplink transmissions/receptions, so the link direction is based on the dynamic scheduling decisions. The behavior can be also beneficial, for example, when flexible symbols are indicated to UEs as DL or UL by the gNB using dynamic TDD indication, such as by a DCI format 2_0. The NCR need not receive or decode such dynamic TDD indication, rather can be informed by the gNB. In either case, it is likely that the DL or UL link direction determination is associated with certain downlink or uplink transmission or reception, which in turn may be associated with a dynamic beam indication for the UE. Such beam information needs to be provided to the NCR, so it is reasonable to provide the DL/UL link direction jointly in a same signaling, such as L1/L2 signaling.

It is noted that beam indexes for the NCR can be associated with different beam types, for example, a first set of NCR beams such as 1#0, #11 can correspond to a first beam type such as wide beams or SSB beams, and a second set of NCR beams such as {#2, #3, . . . , #7, #8} can correspond to a second beam type such as narrow beams or CSI-RS beams. The NCR can determine a beam type based on the beam index or can be separately provided information of a beam type.

The present disclosure can be applicable to NR specifications Rel-18 and beyond to provide on-off information for interference management for various repeater/relay nodes, including SR, also known as NCR.

The present disclosure provides can also apply to various frequency bands in different frequency ranges (FR) such as FR1, FR2, FR3, and FR2-2, e.g., low frequency bands such as below 1 GHz, mid frequency bands, such as 1-7 GHz, and high/millimeter frequency bands, such as 24-100 GHz and beyond. In addition, the embodiments are generic and can apply to various use cases and settings as well, such as single-panel UEs and multi-panel UEs, eMBB, URLLC and IIoT, mMTC and IoT, sidelink/V2X, operation with multi-TRP/beam/panel, operation in NR-U, NTN, aerial systems such as drones, operation with RedCap UEs, private or NPN, and so on.

There is a need for interference management for an NCR, also known as SR, so that the gNB can control in which time/frequency resources the NCR is performing amplify-and-forward operation. In particular, the gNB may be able to switch off the NCR when deemed necessary, in order to avoid interference to serving cells or neighbor cells.

There is another need to determine the relationship between ON-OFF state of an NCR-Fwd, also referred to as NCR remote/radio unit (RU), with various failure or inactivity states of NCR-MT RLF, beam failure detection (BFD)/BFR, discontinuous reception (DRX), RRC_IDLE state or RRC_INACTIVE state (if supported).

Herein, on-off information refers to configuration or indication from gNB to NCR about an ON state in which the NCR-Fwd is switched on and operational to perform an amplify and forward operation, or an OFF state in which the NCR-Fwd is switched off or not operational, so the NCR-Fwd does not perform an amplify and forward operation.

There is a further need to consider reliability of indications, such as on-off indication, by the gNB to the NCR, and latency of application for the corresponding indications.

The present disclosure provides methods and apparatus for on-off information indication for SR, also known as NCR.

In general, the embodiments apply to any deployments, verticals, or scenarios including FR1, FR2 or in FR1+FR2, with eMBB, URLLC and IIoT and extended reality (XR), mMTC and IoT, with sidelink/V2X communications, with multi-TRP/beam/panel, in NR-U, for NTN, for aerial systems such as unmanned aerial vehicles (UAVs) such as drones, for private or NPN, for operation with RedCap UEs, multi-cast broadcast services (MBS), and so on. The SR or NCR may be ground-based or may be satellite/aerial platform based.

Various embodiments, methods, and examples described in the present disclosure can apply beyond NCR/SR nodes to other nodes with a repeater/relay-like functionality in a wireless network, such as reconfigurable intelligent surfaces (RIS), or to stationary or non-stationary repeater/relay-like nodes in the sky/sea or other not-on-the-ground situations, for example, satellites in NTN, or mobile repeaters on buses/trains/vessels/ships/aircrafts/drones, and so on.

In one embodiment, an NCR determines that NCR-Fwd needs to go to the OFF state based on a RLF or beam BFD or BFR event for the C-link of NCR-MT. The NCR-Fwd can go to OFF state when the NCR-MT determines the RLF or BFD event, or when the NCR-MT indicates the corresponding event to the serving gNB, for example, using a PRACH transmission. After a successful radio link re-establishment or after successful BFR for the C-link, the NCR-Fwd can go back to the ON state and transmit with a beam based on a previous beam indication, such as provided by higher layers (MAC or RRC layer) or by layer 1 (PHY layer), such as by a DCI format, or based on a new beam indication information.

In one embodiment, when an NCR-MT is not in active time when C-DRX is configured for the NCR-MT, or when the NCR-MT uses DRX in RRC_IDLE or RRC_INACTIVE state (if supported), the NCR-Fwd can continue to operate based on previously indicated on-off or beam indications, or can stop the operation and go to the OFF state, or a behavior can be unspecified an left to NCR implementation, for example, similar to a NR RF repeater without gNB control.

In one embodiment, when an NCR-MT receives an indication for side control information of NCR-Fwd, such as beamforming or on-off indication, and at least when the indication is provided by a DCI format in a PDCCH, the NCR-Fwd provides HARQ-ACK information corresponding to the DCI format/PDCCH reception and an application time for the corresponding indication can be with respect to a last symbol of the PDCCH reception or a last symbol of a PUSCH/PUCCH transmission that includes the HARQ-ACK information.

In one embodiment, a DCI format for NCR-MT that provides the side control information for NCR-Fwd can be in a dedicated/new DCI format with a CRC scrambled by a C-RNTI or a new RNTI, such as R-RNTI (repeater RNTI) or N-RNTI or NCR-RNTI. A size of the new DCI format can be configured by higher layers or defined in the specifications. An NCR-MT can maintain a DCI size budget and PDCCH monitoring limits as described in TS 38.212 and TS 38.213, or can support reduced DCI size budget or reduced PDCCH monitoring limits to reduce implementation complexity of NCR relative to a UE. A procedure for DCI size alignment can be updated to incorporate a size of DCI format 2_8 scrambled with NCR-RNTI, for example, by matching the size of DCI format 2_8 to a reference DCI format or by adding new steps for DCI format 2_8 to the DCI size alignment procedure for DCI formats with dedicated RNTI.

In one embodiment, for an NCR-MT with capability to receive dedicated signaling such as MAC-CE for determination of backhaul link (BH-link) beam, the MAC-CE provides a TCI state or SRI associated with the active BWP of the control link (C-link). When an active BWP of the C-link is switched, for example via a DCI format or an associated timer, the NCR-Fwd can continue to apply the same beam of the old BWP for the BH-link, or can apply a beam from the new BWP of the C-link with a same beam index as in the old BWP, or can apply a predetermined/default beam based on the PDCCH/PUCCH configuration of the new BWP of the C-link. The NCR applies one of these methods until the NCR-MT receives a new MAC-CE providing a new TCI state or SRI associated with the new BWP of the C-link.

In some examples, the term “beam” is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include all the subbands within the DL system bandwidth. This can also be termed “full-band.” Alternatively, CSI or calibration coefficient reporting band can include only a collection of subbands within the DL system bandwidth. This can also be termed “partial band.” The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher-layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

In the following and throughout the disclosure, various embodiments of the disclosure may be also implemented in any type of UE including, for example, UEs with the same, similar, or more capabilities compared to legacy 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types “D,” “U,” or “F” using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in 3GPP standard specification.

Throughout the present disclosure, the term “configuration” or “higher layer configuration” and variations thereof (such as “configured” and so on) are used to refer to one or more of: a pre-configuration such as by OAM signaling or a system information signaling such as by a MIB or a SIB (such as SIB1), a common or cell-specific higher layer/RRC signaling, or a dedicated or UE-specific or BWP-specific or NCR-specific higher layer/RRC signaling.

The SSB includes PSS, SSS, each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e., using different beams, spanning the coverage area of a cell).

Within the frequency span of a carrier, multiple SSBs can be transmitted. The PCIs of SSBs transmitted in different frequency locations may not be unique, i.e., different SSBs in the frequency domain can have different PCIs. However, when an SSB is associated with an RMSI, the SSB is referred to as a CD-SSB. A PCell is always associated to a CD-SSB located on the synchronization raster.

Polar coding is used for PBCH. The UE may assume a band-specific sub-carrier spacing for the SSB unless a network has configured the UE to assume a different sub-carrier spacing. PBCH symbols carry its own frequency-multiplexed DMRS. QPSK modulation is used for PBCH.

Measurement time resource(s) for SSB-based RSRP measurements may be confined within a SSB measurement time configuration (SMTC). The SMTC configuration provides a measurement window periodicity/duration/offset information for UE RRM measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for RSSI are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

In an RRC_CONNECTED state, the UE monitors PDCCH. This monitoring activity is controlled by the DRX protocol and bandwidth adaptation schemes configured for the UE. The UE only monitors PDCCH on the active BWP, e.g., the UE may not monitor PDCCH on the entire DL bandwidth of the cell. A BWP inactivity timer independent from the DRX inactivity timer is used to switch the active BWP to the default BWP. The BWP inactivity timer is restarted upon successful PDCCH decoding. Switching to the default BWP happens when the timer expires. When DRX is configured, the UE is not required to continuously monitor the PDCCH on the active BWP.

A DRX operation is based on the use of a configurable DRX cycle in the UE. When a DRX cycle is configured, the UE monitors the DL control channel only during the active time and sleeps, with its receiver circuitry switched off, during the inactivity time. This reduces UE power consumption. The longer the DRX inactive time, the lower the UE power consumption. The gNB scheduler however can only reach the UE when the UE is active according to the DRX cycle configured for it. In many cases, if the UE has been scheduled and is receiving or transmitting data, it is likely that it may be scheduled again soon. Waiting until the next activity period according to the DRX cycle may result in additional delays. Therefore, to reduce the delays, the device remains in the active state for a configurable period of time after being scheduled. This is realized by an inactivity timer started by the UE every time that it is scheduled where the UE remains awake until the time expires. Since NR supports different numerologies, the time unit of the DRX timers is specified in milliseconds in order to avoid associating the DRX periodicity to a certain numerology.

The NR HARQ retransmissions are asynchronous in both DL and UL. If the UE has been scheduled a transmission in the DL that the UE cannot decode, a typical gNB behavior is to retransmit the data later. The DRX scheme provides a configurable timer which is started after an erroneously received TB and is used to wake up the UE receiver when it is likely for the gNB to schedule a retransmission. The value of the timer is preferably set to match the (implementation specific) HARQ RTT. For some services such as VoIP characterized by periods of regular transmission, followed by periods of no activity, a second (short) DRX cycle can be optionally configured in addition to the long DRX cycle.

When the UE is not in active time during an OFDM symbol, the UE does not transmit periodic or semi-persistent SRS, does not report CSI on PUCCH or semi-persistent CSI configured on PUSCH. However, regardless of whether the UE is monitoring PDCCH or not on the serving cells in a DRX group during the C-DRX operation, the UE transmits HARQ feedback, aperiodic CSI on PUSCH, and aperiodic SRS on the serving cells in the DRX group when such is expected. In addition, the UE may be configured with a CSI Mask to limit the transmission of CSI reports to the on-duration period of the DRX cycle using the parameter csi-Mask in MAC-CellGroupConfig.

In Rel-15 NR, the DRX operation in RRC_CONNECTED mode, or C-DRX, is characterized by the following parameters. On-duration is the time interval during which the UE may expect to receive the PDCCH. If the UE successfully decodes the PDCCH, the UE stays awake and starts the inactivity timer. Inactivity timer is the time interval during which the UE waits for successful decoding of the PDCCH, starting from the last successful decoding of a PDCCH. If the decoding fails, the UE can go back to sleep. The UE restarts the inactivity timer following a single successful decoding of a PDCCH for the first transmission only, i.e., not for retransmissions. Retransmission-timer is the time interval until a retransmission can be expected. Cycle specifies the periodic repetition of the on-duration followed by a possible period of inactivity. Active time is the total time duration that the UE monitors PDCCH. This includes the on-duration of the DRX cycle, the time that the UE is performing continuous reception while the inactivity timer is running, and the time when the UE is performing continuous reception while awaiting a retransmission opportunity.

With reference to higher layers configured parameters, e.g., RRC, to control the C-DRX operation of a UE: (1) drx-onDurationTimer: the duration at the beginning of a DRX cycle; (2) drx-SlotOffset: the delay before starting the drx-onDurationTimer; (3) drx-InactivityTimer: the duration after the PDCCH occasion in which a PDCCH indicates a new UL/DL transmission for the MAC entity; (4) drx-RetransmissionTimerDL (per-DL HARQ process except for the broadcast process): the maximum duration until a DL retransmission is received; (5) drx-RetransmissionTimerUL (per-UL HARQ process): the maximum duration until a grant for UL retransmission is received; (6) drx-LongCycleStartOffset: the long DRX cycle and drx-StartOffset which define the subframe where the long and short DRX cycle starts; (7) drx-ShortCycle (optional): the short DRX cycle; (8) drx-ShortCycleTimer (optional): the duration in which the UE follows the short DRX cycle; (9) drx-HARQ-RTT-TimerDL (per-DL HARQ process except for the broadcast process): the minimum duration before a DL assignment for HARQ retransmission is expected by the MAC entity; and (10) drx-HARQ-RTT-TimerUL (per-UL HARQ process): the minimum duration before an UL HARQ retransmission grant is expected by the MAC entity.

The triggering condition or timing for a DRX cycle is: [(SFN×10)+subframe number] mod (drx-ShortCycle)=(drx-StartOffset) mod (drx-ShortCycle). If a Short DRX cycle is configured, the “on duration” period starts at a subframe satisfying the condition. Within the calculated subframe, the actual “on duration” starts after a certain slot offset which is determined by drx-SlotOffset.

Upon the expiry of drx-ShortCycleTimer or if Short DRX cycle is not configured, the UE uses the Long DRX cycle with the following triggering condition for the start of “on duration” period: [(SFN×10)+subframe number] mod (drx-LongCycle)=(drx-StartOffset). Again, the actual “on duration” starts after a certain slot offset which is determined by drx-SlotOffset.

When the gNB knows that there is no additional data for the UE in the DL transmit buffer, the gNB can use a MAC CE to signal to the UE to terminate the ongoing active state and enter inactive state. In Rel-15 NR, two MAC CEs can be used. The DRX Command MAC CE using MAC sub-header with LCID=60 forces the UE to terminate the current active time and enter the regular DRX cycle. The MAC CE has a fixed size of zero bits, i.e., no payload. Upon reception, the UE comes out of DRX active state and enters DRX inactive state. The UE enters Short DRX cycle if Short DRX Cycle is configured, else, the UE enters the Long DRX cycle. Note that when a DRX related MAC CE is received by the UE, the corresponding procedure is applied to both the default group and the secondary group. The Long DRX Command MAC CE′ using MAC sub-header with LCID=59 forces the UE to terminate the current active time and enter the Long DRX cycle. The MAC CE has a fixed size of zero bits, i.e., no payload. In this case, the UE enters Long DRX cycle even if the Short DRX cycle is configured. This is useful for example if the gNB determines that there is not going to be any data that requires may require the Short DRX cycle to be used.

With reference to DRX operation in Rel-15 NR when SPS and CG are configured for the UE in the DL or the UL, respectively, the following procedures apply. For SPS, DCI 1_0/1_1 use the configured scheduling-RNTI (CS-RNTI). If a MAC PDU is received, the UE starts the drx-HARQ-RTT-TimerDL in the first symbol after transmitting NACK in the UL. Once drx-HARQ-RTT-TimerDL timer expires, the UE starts the drx-RetransmissionTimerDL timer in the next symbol and becomes active for this duration of this timer. For CG, when the UE transmits a MAC PDU using the configured UL grant, the re-transmission handling is similar to that of regular UL data transmission using dynamic grants. If a MAC PDU is transmitted on PUS CH using a configured UL grant, the UE starts the timer drx-HARQ-RTT-TimerUL in the immediate first symbol after transmitting PUSCH. If PUSCH repetition is configured, then the UE starts the timer after the first PUSCH transmission within a bundle. When the drx-HARQ-RTT-TimerUL timer expires, the UE starts drx- RetransmissionTimerUL timer in the next symbol and becomes active for this duration of this timer to receive re-transmission request(s) from the gNB.

Rel-16 NR supports to configure DRX related parameters for a second DRX group using parameter drx-ConfigSecondaryGroup-r16. All serving cells in the secondary DRX group belong to one FR and all serving cells in the default DRX group belong to another FR. The network configures only drx-InactivityTimer and drx-onDurationTimer as part of this configuration. The network therefore has the flexibility to control “on duration” and “inactivity time” per serving cell. When the second DRX group is configured, the drx-InactivityTimer and drx-onDurationTimer values for the second DRX group are smaller than the respective values configured for the default DRX group in IE DRX-Config. When parameter drx-ConfigSecondaryGroup-r16 is configured, the gNB can indicate which serving cells belong to the secondary group using the IE SCellConfig. If no indication is provided, an SCell belongs to the default DRX group.

IAB enables wireless relaying in NG-RAN. The relaying node, referred to as IAB -node, supports access and backhauling via NR. The terminating node of NR backhauling on network side is referred to as the IAB-donor, which represents a gNB with additional functionality to support IAB. Backhauling can occur via a single or via multiple hops.

The IAB-node supports gNB-DU functionality to terminate the NR access interface to UEs and next-hop IAB-nodes, and to terminate the F1 protocol to the gNB-CU functionality on the IAB-donor. The gNB-DU functionality on the IAB-node is also referred to as IAB-DU.

In addition to the gNB -DU functionality, the IAB -node also supports a subset of the UE functionality referred to as IAB-MT, which includes, e.g., physical layer, layer-2, RRC and NAS functionality to connect to the gNB-DU of another IAB-node or the IAB-donor, to connect to the gNB-CU on the IAB-donor, and to the core network.

The IAB-node can access the network using either SA mode or EN-DC. In EN-DC, the IAB-node connects via E-UTRA to a MeNB, and the IAB-donor terminates X2-C as SgNB.

All IAB-nodes that are connected to an IAB-donor via one or multiple hops form a DAG topology with the IAB-donor as its root. In this DAG topology, the neighbor node of the IAB-DU or the IAB-donor-DU is referred to as child node and the neighbor node of the IAB-MT is referred to as parent node. The direction toward the child node is referred to as downstream while the direction toward the parent node is referred to as upstream. The IAB -donor performs centralized resource, topology and route management for the IAB topology.

F1-U and F1-C use an IP transport layer between IAB-DU and IAB-donor-CU. F1-U and F1-C need to be security-protected.

On the wireless backhaul, the IP layer is carried over the Backhaul Adaptation Protocol (BAP) sublayer, which enables routing over multiple hops. The IP layer can also be used for non-Fl traffic, such as OAM traffic.

On each backhaul link, the BAP PDUs are carried by BH RLC channels. Multiple BH RLC channels can be configured on each BH link to allow traffic prioritization and QoS enforcement. The BH-RLC-channel mapping for BAP PDUs is performed by the BAP entities on each IAB-node and the IAB-donor-DU.

The IAB-MT further establishes SRBs (carrying RRC and NAS) with the IAB-donor-CU. For IAB-nodes operating in EN-DC, the IAB-MT establishes one or more DRBs with the eNB and one or more DRBs with the IAB-donor-CU, which can be used, e.g., to carry OAM traffic. For SA mode, the establishment of DRBs is optional. These SRBs and DRBs are transported between the IAB-MT and its parent node over Uu access channel(s).

Coverage is a fundamental aspect of cellular network deployments. Cellular operators rely on different types of network nodes to offer blanket coverage in their deployments. Deployment of regular full-stack cells, e.g., cells served by a gNB type base stations usually based results in expensive implementation, high cost for equipment and backhaul connectivity. Their deployment is subjected to a variety of constraints such as expensive site leases. While this is the predominant deployment type encountered in practice, it is not always preferred cost-wise. As a result, other types of network nodes have been considered to increase cellular operators' economic flexibility for their network deployments.

For example, IAB was introduced in 5G NR Rel-16 and enhanced in Rel-17 as a new type of network node not requiring a wired backhaul. IAB nodes can be considered full-stack cells similar to gNBs. The IAB node is a new type of relay node building over the front-haul architecture and constituting a node with a dual role including an IAB DU component making it possible to appear as a regular cell to the UEs which the DU serves, and an IAB mobile terminal (MT) component inheriting many properties of a regular UE whereby the IAB node connects to its donor parent node(s) or a gNB. The IAB node is based on a Layer 2 architecture with end-to-end PDCP layer from the donor IAB node to the UE for CP and UP. IAB nodes can also be classified as re-generative relays. Every packet traversing the link between the donor node and the IAB-MT component of the IAB node, i.e., the backhaul-link, may be properly decoded and re-encoded by the IAB node for further transmission to the UE on the access link. The first version of IAB in Rel-16 NR assumes half duplex operation in TDM between access and backhaul links for transmission and reception by the IAB node but includes features for forward compatibility towards evolving IAB using full duplex operation. Rel-17 NR further enhances IAB operation with better support of full duplex implementations of IAB nodes.

Another type of network node is the RF repeater which amplifies-and-forwards any signal that the repeater receives. RF repeaters have seen a wide range of deployments in 2G GSM/(E)GPRS, 3G WCDMA/HSPA and 4G LTE/LTE-A to supplement the coverage provided by regular full-stack cells. RF repeaters constitute the simplest and most cost-effective way to improve network coverage. The main advantages of RF repeaters are their low-cost, their ease of deployment and the fact that they do not much increase latency. The main disadvantage is that they amplify both desired signal(s) and (undesired) noise and hence, often contribute to an increase of interference levels observed at system level. Within RF repeaters, there are different categories depending on the power characteristics and the amount of spectrum that they are configured to amplify, e.g., single band, multi-band, etc. RF repeaters are considered non-regenerative type of relay nodes. RF repeaters are typically full-duplex nodes and they do not differentiate between UL and DL transmissions or receptions. LTE specifies RF repeater requirements in 36.106. Their use is limited to LTE FDD bands.

In Rel-17 NR, RF and EMC requirements in FR1 and FR2 for RF repeaters using NR were introduced. As NR often uses higher frequencies, e.g., 3-4 GHz in FR1 and above 24 GHz for FR2, propagation conditions are degraded when compared to lower frequencies in use by LTE. This exacerbates the coverage challenges for NR. More densification of cells becomes necessary. Massive MIMO operation in FR1, analog beamforming in FR2 and multi-beam operation with associated beam management in FR1 and FR2 are integral part of the NR design to cope with the challenging propagation conditions of these higher frequencies. Note that these NR frequency bands are TDD. In consequence, simultaneous or bi-directional amplify-and-forward as employed by traditional RF repeaters is not always necessary (unlike in the FDD LTE case) and can therefore be avoided. This much reduces the noise pollution problem of regular RF repeaters which amplify both (undesired) noise and desired signal(s). Beamformed transmissions and receptions to/from individual NR users are a fundamental feature and inherent to NR operation. However, the use of a simple RF repeater operating in the NR network implies that the prerequisite beamforming gains for NR operation to provide coverage are not available when relaying the NR transmissions and receptions. While a conventional RF repeater presents a very cost-effective means of extending network coverage, the repeater has limitations when considering NR.

Therefore, a new type of network node, somewhere in-between RF repeaters and IAB nodes is a compelling proposition to try to leverage the main advantages of both. That new type of network node, i.e., a SR or NCR can make use of some SCI or NCI to enable a more intelligent amplify-and-forward operation in a system with TDD access and multi-beam operation. SCI or NCI allows an NCR or SR to perform the amplify-and-forward operation in a more efficient manner. Potential benefits include mitigation of unnecessary noise amplification, transmissions and receptions with better spatial directivity, and much simplified network integration.

In C-plane, a SR or NCR may be provided or configured by the gNB with information on semi-static and/or dynamic downlink/uplink configuration, adaptive transmitter/receiver spatial beamforming, Tx on/off status, etc. In U-plane, the SR or NCR is still non-regenerative, e.g., the SR or NCR employs amplify-and-forward to relay the actual UE signals from/to the gNB. SCI or NCI transmission and requires only low capacity for the control backhaul between the donor cell(s), e.g., gNB and the SR. As a result, the low-complexity and low-cost properties of RF repeaters are mostly preserved while a degree of network configurability and control is enabled similar to eIAB nodes.

In the user plane, the SR or NCR receives the incoming RF signal from the gNB (or the UE) at its ingress antenna port, then amplifies-and-forwards the RF signal to its egress antenna port to the UE (or gNB). Note that similar to a conventional RF repeater, the amplified-and-forwarded signal traverses the RF path, e.g., is the signal is processed in analog domain.

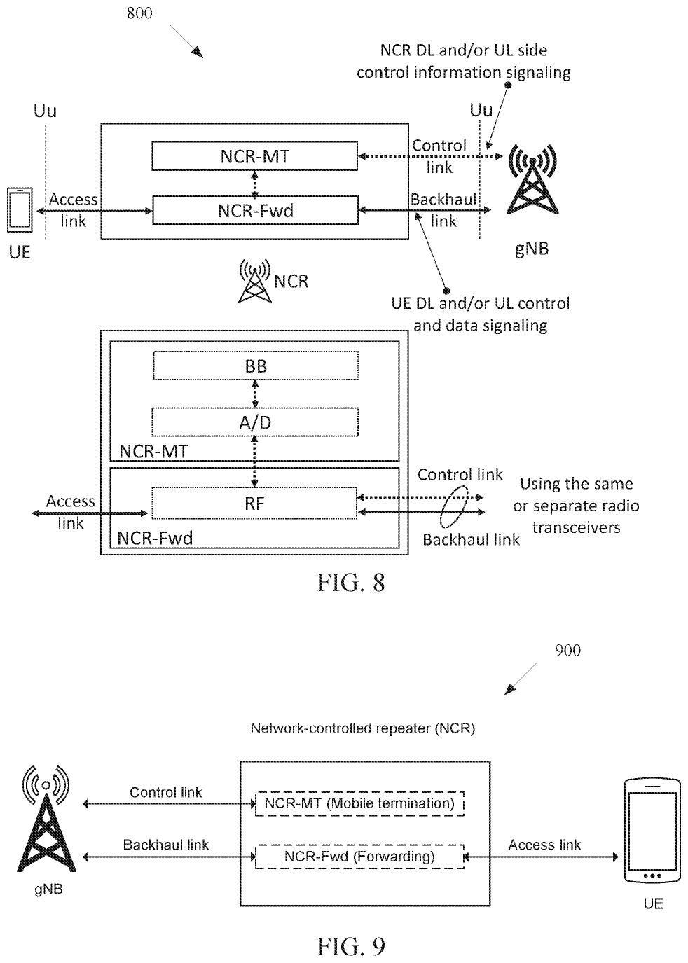

In the control plane, e.g., when transmitting DL side control information (DL SCI or NCI) from gNB to the NCR, or when transmitting UL side control information (UL SCI or NCI) from the NCR to the gNB, the signal processing by the NCR differs. For transmission of DL NCI, the gNB can use one or a combination of signaling options. DL NCI can be transmitted in L1, e.g., by DCI or in any DL control channel, in L2 MAC, e.g., by MAC CE(s) or as part of any DL data channel, in L2 RRC, e.g., by RRC signaling messages and/or IEs. Without loss of generality and illustration purposes, it may be assumed that the NCR converts part of the incoming (DL) RF signal from the gNB to digital domain to determine presence and further process the received signaling contents of DL NCI. For transmission of UL NCI to the gNB, it may be assumed that the NCR receives the incoming RF signal from the UE at its ingress antenna port, then amplifies-and-forwards the RF signal while adding the UL NCI following its conversion from digital signaling processing to analog domain for transmission at the egress antenna port (e.g., as shown in FIG. 8).

For transmission of UL NCI, the SR can use one or a combination of signaling options. UL NCI can be transmitted in L1, e.g., by an UL control or data channel, in L2 MAC, e.g., by MAC CE(s) or as part of any UL data channel, in L2 RRC, e.g., by RRC signaling messages and/or IEs. Note that the NCR may also be configured or provisioned or receive or transmit signaling messages using NAS protocol messages, e.g., CM, SM, etc., and/or by O&M signaling. Furthermore, transmission and reception of DL and UL NCI may occur using in-band signaling, e.g., using the same frequency band/channel as the amplified-and-forwarded UE signal(s), or may occur using out-of-band signaling, e.g., NCI is transmitted and received using a different band, channel, or frequency range than the amplified-and-forwarded UE signal(s).

FIG. 8 illustrates an example of a functional architecture 800 for a SR or NCR according to embodiments of the present disclosure. An embodiment of the functional architecture 800 for a SR or NCR shown in FIG. 8 is for illustration only.

FIG. 9 illustrates an example of a functional architecture 900 of an NCR according to embodiments of the present disclosure. An embodiment of the functional architecture 900 of the NCR shown in FIG. 9 is for illustration only.

An example of NCR as illustrated in 3GPP standard specification shown in FIG. 9, which includes the NCR-MT and NCR-Fwd.

The NCR-MT is defined as a functional entity to communicate with a gNB via a control link (C-link) to enable exchange of control information (e.g., side control information at least for the control of NCR-Fwd). The C-link is based on NR Uu interface. The NCR-Fwd is defined as a functional entity to perform the amplify-and-forwarding of UL/DL RF signal between gNB and UE via backhaul link and access link. The behaviour of the NCR-Fwd may be controlled according to the received side control information from gNB.

Throughout the present disclosure, an NCR-MT may also be referred to as SR-MT; an NCR-Fwd may also be referred to as SR-RU or NCR-RU; an NCR backhaul link or an NCR C-link may also be referred to as the NCR-to-gNB link; and the NCR access link may also be referred to as the NCR-to-UE(s) link. These pairs of terms may be used interchangeably.

In some technical examples, at least one of the NCR-MT's carrier(s) may operate in the frequency band forwarded by the NCR-Fwd. In other examples, an NCR-Fwd may operate with multiple passbands/carriers in same or different frequency band, and a corresponding NCR-MT may operate in one or more passbands/carriers from the multiple passbands/carriers for NCR-Fwd operation in one or more frequency bands. In one example, the NCR-MT may additionally or alternatively operate in carrier(s) outside the frequency bands in which NCR-Fwd operates. Herein, a passband can refer to a frequency range in which a repeater/NCR_Fwd operates in with operational configuration. Such frequency range can correspond to one or several consecutive nominal channels. When an operating frequency for an NCR-Fwd is not consecutive, each subset of channels may be considered as an individual passband. An NCR-Fwd can have one or several pas sbands.

In some technical examples, same large-scale properties of the channel, i.e., channel properties in Type-A and Type-D (if applicable), can be experienced by C-link and backhaul link (at least when the NCR-MT and NCR-Fwd are operating in same frequency band).

For the transmission/reception of C-link and backhaul link by NCR, signaling on the DL of the C-link and the DL of backhaul link may be performed simultaneously or in TDM, or the signalling of the UL of the C-link and UL of backhaul link may be performed in TDM. The multiplexing may be under the control of gNB with consideration for NCR capability. Simultaneous transmission of the UL of the C-link and the UL of backhaul link may be subject to NCR capability.

Various embodiments, methods, and examples described in the present disclosure can apply beyond NCR/SR nodes to other nodes with a repeater/relay-like functionality in a wireless network, such as RIS or to stationary or non-stationary repeater/relay-like nodes in the sky/sea or other not-on-the-ground situations, for example, satellites in NTN, or mobile repeaters on bu se s/trains/ves s els/ship s/aircrafts/drone s, and so on.

Throughout the present disclosure, a gNB -to-NCR link is used to refer to one or both of an NCR C-link or an NCR backhaul link. Throughout the present disclosure, an NCR-to-UE link is used to refer to an NCR access link.

Throughout the present disclosure, an ON state for an NCR refers, for example, to a mode of operation where the NCR is switched on, functional and operational, and NCR-Fwd performs an amplify-and-forward operation. When operating in the ON state, for example, the NCR-Fwd operates with a nominal/maximum amplification gain per NCR implementation (above a certain threshold for ON state) or with an indicated amplification gain by a serving gNB, for example when an indicated amplification gain is supported by the NCR-Fwd capability.

Throughout the present disclosure, an OFF state for an NCR refers, for example, to a mode of operation where the NCR is switched off, or is not functional or operational, or NCR-Fwd does not perform any amplify-and-forward operation. When operating in the OFF state, for example, the NCR-Fwd does not operate at all (that is, completely switched off) or operates with zero or very small amplification gain that is smaller than a certain threshold for the OFF state.

In one embodiment, an NCR determines that NCR-Fwd needs to go to the OFF state based on a RLF or BFD or BFR event for the control link (C-link) of NCR-MT. The NCR-Fwd can go to OFF state when the NCR-MT determines the RLF or BFD event, or when the NCR-MT indicates the corresponding event to the serving gNB, for example, using a PRACH transmission. After a successful radio link re-establishment or after successful BFR for the C-link, the NCR-Fwd can go back to the ON state and transmit with a beam based on a previous beam indication, such as provided by higher layers (MAC or RRC layer) or by layer 1 (PHY layer), such as by a DCI format, or based on a new beam indication information.

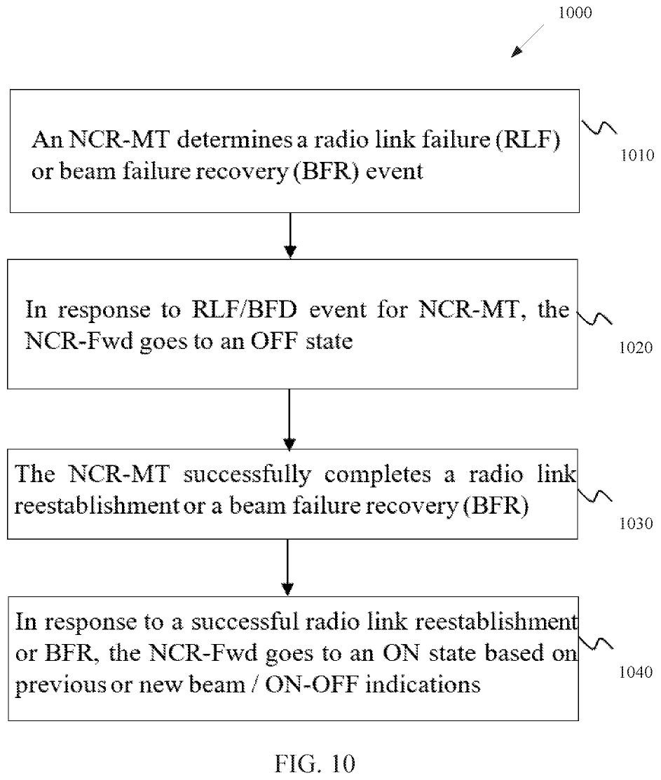

FIG. 10 illustrates a flowchart of procedure 1000 for a determination of ON or OFF state for NCR-Fwd based on RLF or BFR event for NCR-MT. The procedure 1000 as may be performed by a TRP (e.g., TRP 200 in FIG. 2). An embodiment of the procedure 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

An NCR-MT determines a RLF or BFR event, 1010. In response to RLF/BFD event for NCR-MT, the NCR-Fwd goes to an OFF state, 1020. The NCR-MT successfully completes a radio link reestablishment or a BFR, 1030. In response to a successful radio link reestablishment or BFR, the NCR-Fwd goes to an ON state based on previous or new beam/on-off indications, 1040.

In one example, when the PHY/MAC layer of NCR-MT determines and declares an RLF or a BFD, the NCR-Fwd suspends any amplify-and-forward operation and goes to OFF state. In another example, when the NCR-MT initiates a random access procedure in response to the trigger by the RLF or BFD event, the NCR-Fwd can suspend any amplify-and-forward operation and go to the OFF state when the NCR-MT: (1) transmits a first/initial PRACH; (2) receives a RAR in response to the PRACH; or (3) successfully completes the random access procedure.

In yet another example, the NCR-Fwd can go to the OFF state when the NCR-MT transmits a PUCCH in response to the trigger by the BFD event.

For example, the NCR-MT can apply the OFF state a number N symbols or slots after a condition, from the above conditions, is satisfied. A value for N can be defined in the specifications of system operation, or can be provided by higher layers. The value for N can be different based on an SCS defined in the specifications of a system operation, such as 15 kHz, or based on the operating frequency range (such as FR1, FR2, and FR2-2), or based on an applicable SCS configuration, such as an SCS configuration for the active DL/UL BWP of a (primary) serving cell for NCR-MT, or a (smallest/largest) SCS configuration of passband(s) operated by the NCR-Fwd. Alternatively, an absolute time value, for example in milliseconds, can be defined for the NCR-MT to apply the OFF state.

For example, when the NCR-MT successfully completes the radio link re-establishment or beam failure recovery, the NCR-Fwd continues to operate with previous beam indications for access and/or backhaul link, that were provided to the NCR before RLF/BFD/BFR by higher layers or by layer 1 such as by a DCI format. In one example, the NCR-Fwd can continue to operate with previous beam indications only after successful completion of the BFR procedure, but not for RLF. For example, after successful completion of the radio link re-establishment, the NCR can assume that any previous beam indication for access and/or backhaul link is invalid. Then, a new beam indication needs to be provided to the NCR, by higher layers or by Layer 1, for the access link or the backhaul link. In yet another example, a new beam indication needs to be provided to the NCR after both RLF and BFD/BFR for the access link or the backhaul link after successful completion of both the radio link re-establishment and BFR.

In another example, any previous beam indication for the access link remains valid after RLF/BFD/BFR of NCR-MT, and new beam indication is needed only for the backhaul link (and C-link). In a further example, the NCR-Fwd starts to operate with previous or a new beam indication for the access link or the backhaul link at M symbols or slots after successful completion of both the radio link re-establishment and BFR. A value M can be same or different from the value N, as described above, and can be defined in a similar manner. It is also possible that instead of M symbols or slots, an absolute time such as in milliseconds is defined in the specifications of the system operation or as indicated as part of a capability report by the NCR.

In one example, the NCR can be provided information of an association among configured/activated beams for the backhaul link and configured/indicated beams for the access link. For example, a first set of beams for access link can be mapped to a first beam for backhaul link, and a second set of beams for the access link can be mapped to a second beam for backhaul link. For example, beam indexes {1, 2, 3, 4} on the access link can be associated with beam #1 on the backhaul link, and beam indexes 15, 6, 7, 81 on the access link can be associated with beam #2 on the backhaul link. Such association can be used to determine a set of valid beams after RLF/BFD/BFR. For example, after successful completion of BFR, the NCR-MT determines a new beam new (for example, for PDCCH monitoring in a CORESET with index 0) for the C-link, and the NCR-Fwd applies a set of beams on the access link that are mapped to the new beam new (or a beam for the backhaul link that is QCL with the new beam anew) based on the provided association. For example, if the new beam new is same as, or QCLed with, beam #2 of the backhaul link, the NCR-Fwd applies the beam indexes {5, 6, 7, 8} for the access link.

In one embodiment, when an NCR-MT is not in active time when connected mode DRX (C-DRX) is configured for the NCR-MT, or when the NCR-MT uses DRX in RRC_IDLE or RRC_INACTIVE state (if supported), the NCR-Fwd can continue to operate based on previously indicated on-off or beam indications, or can stop the operation and go to the OFF state, or a behavior can be unspecified an left to NCR implementation, for example, similar to a NR RF repeater without gNB control.

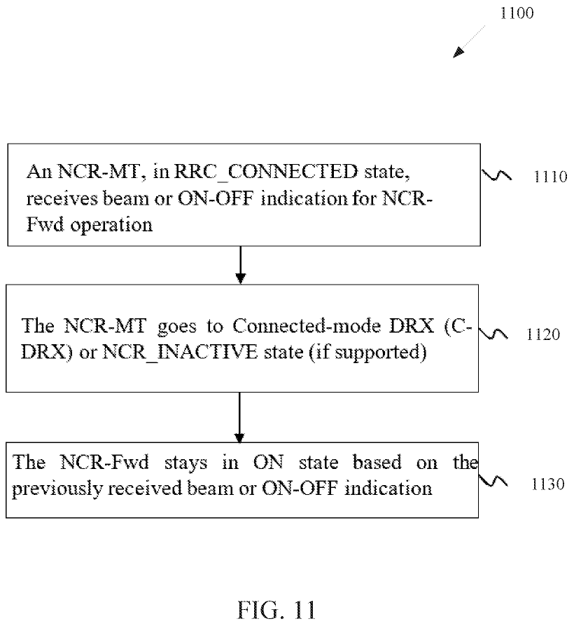

FIG. 11 illustrates a flowchart of procedure 1100 for a determination of on or OFF state or beam indication for NCR-Fwd during C-DRX or RRC_IDLE or RRC_INACTIVE state of NCR-MT according to embodiments of the present disclosure. The procedure 1100 as may be performed by a TRP (e.g., TRP 200 in FIG. 2). An embodiment of the procedure 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, an NCR-MT, in RRC_CONNECTED state, receives beam or on-off indication for NCR-Fwd operation, 1110. The NCR-MT goes to Connected-mode DRX (C-DRX) or NCR_IDLE state or NCR_INACTIVE state (if supported), 1120. The NCR-Fwd stays in ON state based on the previously received beam or on-off indication, 1130.

When the NCR-MT is in a DRX off-duration or not in active time or when the NCR-MT uses DRX in RRC_IDLE or RRC_INACTIVE state, in one example, the NCR continues to operate based on previously indicated beam, for example by higher layers or by Layer 1, or on-off indication provided for the access link or the backhaul link of NCR-Fwd.

In another example, when the NCR-MT is in a DRX off-duration or not in active time, or when the NCR-MT uses DRX in RRC_IDLE or RRC_INACTIVE state, the NCR-Fwd also goes to the OFF state and does not perform any amplify-and-forward operation. In one example, such behavior (NCR-Fwd goes to the OFF state) is applicable after all previously provided beam indications or on-off indications for the access link or the backhaul link of NCR-Fwd expire before the DRX-off cycle of NCR-MT finishes or before NCR-MT returns to the RRC_CONNECTED state from the RRC_IDLE or RRC_INACTIVE state. A timer or counter value may be provided by the gNB to the NCR-MT to configure the NCR-MT with a duration or time-period during which previously provided beam indications or on-off indications remain valid or invalid.

In yet another example, when the NCR-MT is in a DRX off-duration or not in active time, or when the NCR-MT uses DRX in RRC_IDLE or RRC_INACTIVE state, the NCR-Fwd operates with a reference beam for the access link or the backhaul link. For example, the NCR-Fwd operates the access link using a beam with smallest (or largest) beam index among all access link beams, or using a beam with smallest (or largest) beam index among access link beams of a certain beam type, such as only wide beams (or only narrow beams). For example, the NCR-Fwd operates the backhaul link with a beam that was configured/activated/indicated by a most recent signaling from the gNB, or based on a reference beam that is defined in the specifications of the system operation such as a default beam for PUSCH or PDSCH as described in TS 38.213 or TS 38.214.

For example, the reference/default beam can be: (1) a spatial relation corresponding to a dedicated PUCCH resource with a lowest ID on an active UL BWP of a primary serving cell of NCR-MT; (2 a spatial relation corresponding to an RS configured with qcl-Type set to “typeD” corresponding to the QCL assumption of the CORESET with the lowest ID on an active DL BWP of a primary cell of the NCR-MT, for example, when a CORESET is configured; or (3) a spatial relation corresponding to an RS configured with qcl-Type set to “typeD” corresponding to the QCL assumption of a (first) activated TCI state for PDSCH with a lowest ID on an active DL BWP of a primary cell of the NCR-MT, for example, when no CORESET is configured.

In one example, such behavior (i.e., following a default/reference beam) is applicable after all previously provided beam indications and/or on-off indications for access link and/or backhaul link of NCR-Fwd expire before DRX-off cycle of NCR-MT is finished or before NCR-MT returns to RRC_CONNECTED state from the RRC_IDLE or RRC_INACTIVE state. A timer or counter value may be provided by the gNB to the NCR-MT to configure the NCR-MT with a duration or time-period during which previously provided beam indications or on-off indications remain valid or invalid.

In yet another example, when the NCR-MT is in a DRX off-duration or not in active time, or when the NCR-MT uses DRX in RRC_IDLE or RRC_INACTIVE state, a behavior of NCR-Fwd is unspecified and left for NCR implementation. For example, the NCR-Fwd may stay in ON state, and operate based on beams selected for the access link and/or backhaul link based on NCR implementation, for example, similar to a NR RF repeater without gNB control. In one example, such behavior (i.e., NCR operation based on NCR implementation) is applicable after all previously provided beam indications or on-off indications for the access link or the backhaul link of NCR-Fwd expire before the DRX-off cycle of NCR-MT finishes or before the NCR-MT returns to the RRC_CONNECTED state from the RRC_IDLE or RRC_INACTIVE state. A timer or counter value may be provided by the gNB to the NCR-MT to configure the NCR-MT with a duration or time-period during which previously provided beam indications or on-off indications remain valid or invalid. In one example, selection of beam per NCR implementation may apply only to the access link, while selection of beam for backhaul link can follow previous beam indications for backhaul link and/or for C-link or may follow a default/reference beam, as described above.

In one embodiment, when an NCR-MT receives an indication for side control information of NCR-Fwd, such as beamforming or on-off indication, and at least when the indication is provided by a DCI format in a PDCCH, the NCR-Fwd provides HARQ-ACK information corresponding to the DCI format/PDCCH reception and an application time for the corresponding indication can be with respect to a last symbol of the PDCCH reception or a last symbol of a PUSCH/PUCCH transmission that includes the HARQ-ACK information.

Side control information for NCR-Fwd can include one or more of: beam indication for NCR-Fwd access or backhaul link, or on-off indication for NCR-Fwd, or TDD DL/UL information such as for flexible symbols, or power control information for NCR-Fwd, such as amplification gain or maximum output power of NCR-Fwd, and so on. Indications can include at least those provided via a DCI format in a PDCCH, also referred to as dynamic indication. More details on DCI formats for NCR side control information are provided in embodiments as disclosed in the present disclosure.

In one example, an NCR-MT provides HARQ-ACK information corresponding to a PDCCH/DCI format reception that includes side control information for NCR-Fwd. An application time for the indication provided by the DCI format can be with respect to a last symbol of a PUCCH/PUSCH that includes corresponding HARQ-ACK information or with respect to an absolute time for example in milliseconds that can be defined in the specifications of the system operation or can be indicated as part of an NCR capability report.

For example, the NCR-Fwd applies the corresponding access beam indication or on-off information indication: (1) N symbols/slots after a last symbol of the PUCCH/PUSCH, or (2) N symbols/slots after a last symbol of a last slot of the serving cell/carrier/passband on which the indication applies that overlaps with the last symbol of the PUCCH/PUSCH.

The latter case above can be beneficial, for example, when an SCS of the serving cell of NCR-MT on which the NCR-MT transmits the PUCCH/PUSCH is different from an SCS of a serving cell/carrier/passband on which the NCR-Fwd applies the side control information indication (e.g., the access beam indication) provided by the PDCCH. In one example, when the gNB does not receive HARQ-ACK information for a corresponding dynamic indication of side control information via a DCI format/PDCCH, the gNB may assume that the NCR-Fwd missed the DCI format and did not apply the corresponding indication, or that the NCR-Fwd applied a previous indication (for example, provided by higher layers such as RRC or MAC-CE) or a default indication, such as a default beam or a default on-OFF state (such as an OFF state).

The symbols/slots are with respect to: (1) an SCS configuration of the active DL/UL BWP of a serving cell on which the NCR-MT transmits the PUCCH/PUSCH; (2) a largest/smallest SCS configuration among the active DL/UL active BWPs of serving cells configured to NCR-MT; (3) an SCS configuration associated with the serving cell/carrier/passband on which the NCR-Fwd applies the side control information indication; (4) a largest/smallest SCS configuration associated with the serving cells/carriers/passbands on which the NCR-Fwd operates (i.e., configured to perform the amplify-and-forward operation); (5) an SCS provided by higher layer information for the side control information indication; (6) an SCS provided within the DCI format that includes the indication (when the DCI format includes multiple indications a same SCS or a separate SCS can be provided for the multiple indications); or (7) a reference SCS that may depend on a frequency range for NCR-MT and/or NCR-Fwd operation, such as 30 kHz for FR1 and 120 kHz for FR2.

In another example, an NCR-MT provides HARQ-ACK information corresponding to a PDCCH/DCI format that includes side control information for NCR-Fwd. An application time for the indication is with respect to a last symbol of the PDCCH.

For example, the NCR-Fwd applies the corresponding access beam indication or on-off information indication at an absolute time after a last symbol of the PDCCH, or: (1) N symbols/slots after a last symbol of the PDCCH, or (2) N symbols/slots after a last symbol of a last slot of the serving cell/carrier/passband on which the indication applies that overlaps with the last symbol of the PDCCH, wherein SCS can be defined as described above, except that for additional cases can be considered wherein “PUCCH/PUSCH” can be replaced with “PDCCH.”

For example, in response to a PDCCH that includes side control information for NCR-Fwd, such as in slot n, the NCR-MT can provide a corresponding HARQ-ACK information, such as in slot n+k1, wherein k1 is a value for PDCCH_to_HARQ_timing indicator in the DCI format, while the application time for the side control information, such as the application time of the access beam indication or on-off information, can be with respect to the last symbol of the PDCCH that provides the control information, such as in slot n+d, wherein d is the application time gap, such as beamAppTime for TCI state indication, instead of the last symbol of a PUSCH/PUCCH transmission that includes a corresponding HARQ-ACK information (that is, instead of slot n+k1+d).

Such behavior can be beneficial, for example, to maintain the acknowledgement information available to the gNB for network configuration or scheduling purposes while reducing a latency of beam application timing since the indication can be applied without a delay associated with the transmission/reception of a PUCCH/PUSCH with the corresponding HARQ-ACK information. In one example, when the gNB does not receive HARQ-ACK information for a corresponding dynamic indication of side control information via a DCI format/PDCCH, the gNB may assume that the NCR-Fwd missed the DCI format and did not apply the corresponding indication, or that the NCR-Fwd applied a previous indication (for example, provided by higher layers such as RRC or MAC-CE) or a default indication, such as a default beam or a default on-OFF state (such as an OFF state).

In yet another example, the NCR does not expect to provide HARQ-ACK information corresponding to a PDCCH that includes side control information for the NCR-Fwd. According to the example in the present disclosure, the NCR-MT determines the application time of the side control information indication from a last symbol of the PDCCH that includes the indication. For example, the NCR applies the corresponding access beam indication or on-off information indication after an absolute time (that can be defined in the specifications or be indicated by the NCR as part of a capability report) from the last symbol of the PDCCH, or: (1) N symbols/slots after a last symbol of the PDCCH, or (2) N symbols/slots after a last symbol of a last slot of the serving cell/carrier/passband on which the indication applies that overlaps with the last symbol of the PDCCH.

The latter case above can be beneficial, for example, when an SCS of the serving cell of NCR-MT on which the NCR-MT receives the PDCCH is different from an SCS of a serving cell/carrier/passband on which the NCR-Fwd applies the side control information indication (e.g., the access beam indication) provided by the PDCCH.

In one example, a single behavior for NCR-MT for acknowledgement of PDCCH for NCR, for example, from the examples mentioned in the present disclosure can be defined in the specifications. For example, the specifications can support only the example in the present disclosure. In another example, more than one behaviors for NCR-MT can be supported in the specifications of the system operation and a selection for a behavior can be indicated by a serving gNB such as by higher layer/RRC information or by a DCI format. For example, the NCR-MT can be provided by a higher layer information element an indication for the examples in the present disclosure. For example, the DCI format that includes the side control information indication, such as the access beam indication or on-off indication, can include a field to enable or disable a corresponding HARQ-ACK information report or to indicate whether an application time for the indication is with respect to the timing of PDCCH reception or with respect to the timing of PUSCH/PUCCH transmission that includes the HARQ-ACK information.

HARQ-ACK information corresponding to the indication for side control information of NCR-Fwd can include a 1-bit indication providing an ACK value when the NCR-MT detects (correctly decodes) a DCI format providing the indication. When the NCR reports HARQ-ACK information for only the DCI format, the transmission of the PUCCH by itself implicitly indicates a correct detection of the DCI format and a modulation need not apply (that is, the PUCCH can include a transmission of an unmodulated sequence that is defined in the specifications); otherwise, the UE does not transmit the PUCCH.

The NCR-MT can provide the HARQ-ACK information in a PUSCH transmission by the NCR-MT, if/when scheduled, or in a PUCCH transmission. A timing for transmission of the PUCCH or PUSCH that includes the corresponding HARQ-ACK can be defined in the specifications for system operation, such as K slots, or can be indicated by higher layer (pre-) configuration such as by RRC or OAM, or can be included in the DCI format that provides the indication. A timing for transmission of a PUCCH with the HARQ-ACK information refers to a number of symbols or slots, in the SCS configuration of an active UL BWP of a serving cell of an NCR-MT with PUCCH configuration, such as a primary cell (PCell) of NCR-MT, from a last symbol of the PDCCH reception to a first symbol of PUCCH (or PUSCH) transmission. For example, the timing for transmission of the PUCCH with HARQ-ACK information can include a number of slots per SCS of PUCCH cell as described above, from a last PUCCH slot that includes a last symbol of the PDCCH until a slot in which a PUCCH (or PUSCH) with HARQ-ACK information may be transmitted.

When the timing is included in the same DCI format that provides the indication for side control information, a DCI field with, for example, 3 bits can be used to indicate one of 8 values. For example, the 8 values can be defined in the specifications of the system operation, such as {0, 1, 2, 3, 4, 5, 6, 7}, or can be provided by higher layer (pre-)configuration. For example, a value “000” can indicate a first (pre-)configured value for HARQ-ACK timing, a value “001” can include a second (pre-)configured value for HARQ-ACK timing, and so on.

The above examples can also apply to NCR side control information that is provided via a PDSCH. For example, when an NCR-MT receives side control information via MAC-CE or RRC information in a PDSCH, similar examples as above may apply. For example, in response to a PDSCH that includes side control information for NCR-Fwd, such as in slot n, the NCR-MT can provide corresponding HARQ-ACK information in a PUCCH transmission in a slot n+k1, wherein k1 is a value for PDSCH_to_HARQ_timing indicator, while the application time for the side control information, such as the application time of the access beam indication or on-off information, can be with respect to the last symbol of the PDSCH that provides the control information, such as in slot n+d, wherein d is the application time gap such as beamAppTime in TCI state indication, instead of the last symbol of the PUSCH/PUCCH transmission that includes the corresponding HARQ-ACK information, that is instead of in slot n+k1+d.

In one embodiment, a DCI format for NCR-MT that provides the side control information for NCR-Fwd can be in a dedicated/new DCI format with a CRC scrambled by a C-RNTI or a new RNTI, such as R-RNTI (repeater RNTI) or N-RNTI or NCR-RNTI. A size of the new DCI format can be configured by higher layers or defined in the specifications. An NCR-MT can maintain a DCI size budget and PDCCH monitoring limits as described in TS 38.212 and TS 38.213, or can support reduced DCI size budget or reduced PDCCH monitoring limits to reduce implementation complexity of NCR relative to a UE. A procedure for DCI size alignment can be updated to incorporate a size of DCI format 2_8 scrambled with NCR-RNTI, for example, by matching the size of DCI format 2_8 to a reference DCI format or by adding new steps for DCI format 2_8 to the DCI size alignment procedure for DCI formats with dedicated RNTI.

In one example, a DCI format for NCR-MT that provides the side control information for NCR-Fwd, such as beamforming information for access link or on-off information for NCR-Fwd, can be a DCI format with CRC scrambled by a C-RNTI for NCR-MT. The NCR-MT can be provided to the C-RNTI after a completion of a random access procedure. In another example, the DCI format can be with CRC scrambled by a new RNTI, such as R-RNTI or N-RNTI or NCR-RNTI that is (pre-)configured by higher layers such as RRC or OAM. For example, the DCI format can be a new DCI format for repeater functionalities such as, with respect to DCI formats defined in TS 38.212, a new DCI format 1_4 (without downlink scheduling/assignment) or a new DCI format for NCR-group-common signaling such as a new DCI format 2_8 for NCR control information indication, or a new DCI format (dedicated) for NCRs such as DCI format 5_0 or 5_1.

For example, a DCI format for NCR-MT that provides the side control information for NCR-Fwd, can have a configurable size per RRC indication, or can have a same size as another DCI format for the NCR-MT, such as DCI format 1_0 (or 0_0). For example, DCI format 1_0 or 0_0 may be used for functionalities of NCR-MT such as acquisition of system information (SI), paging, random access (RA), and so on. In one example, certain DCI formats may not be applicable to an NCR-MT, such as one or more of DCI formats 1_1/1_2/0_1/0_2.

In one example, an NCR-MT monitors a DCI format that provides the side control information for NCR-Fwd in a CORESET #0 associated with a search space set #0 (SS#0) that the UE determines during initial access to a cell, or in a different CORESET or search space set that is indicated to NCR-MT for example by dedicated higher layer signaling such as RRC or OAM. For example, a CORESET or search space set for monitoring PDCCH for detection of DCI formats for NCR side control information can be provided commonly to different NCR nodes connected to a same serving cell/gNB, such as by an NCR-common system information, SIBx, with x>1.

For example, an NCR-MT can distinguish first DCI formats that provide side control information for NCR-Fwd from second DCI formats applicable to NCR-MT based on at least one of the following: a different RNTI for the first and second DCI formats, a different size for the first and second DCI formats, or by an explicit identifier or flag within each of the first and second DCI formats, such as a 1-bit or 2-bit field to indicate whether a DCI format is for procedures such as for SI/paging/RA scheduling, or for scheduling side control information for NCR-Fwd.

In another example, an NCR can distinguish a purpose of second DCI formats, such as a DCI format for beam indication for NCR-Fwd access link compared to a DCI format for on-off indication for NCR-Fwd, based on an explicit identifier in the second DCI formats such as a 1-bit or 2-bit flag. For example, a value “00” can indicate beam indication for access link, a value “01” can indicate on-off information, a value “10” can indicate TDD DL/UL information such as for flexible symbols, and a value “11” can indicate indication of power control parameters. In another example, an explicit identifier may not be provided by the second DCI formats that includes side control information for NCR-Fwd. Instead, a unified DCI format design, such as same DCI fields, can be used for different side control information, and the NCR-MT can distinguish different purposes of the second DCI formats based on values provided for the corresponding DCI fields. For example, the second DCI formats can include a field for beam indication, with a value from the set {1, 2, . . . , N} indicating one of N beams for the access link, a value “0” indicating an ON states (without access beam indication, such as for FR1), or a value “−1” indicating an OFF state.

For example, a DCI size budget for an NCR-MT can be same as for a UE as described in TS 38.212 and TS 38.213. For example, the DCI size budget can be for up to 4 DCI format sizes for NCR-MT and up to 3 DCI format sizes for DCI formats with CRC scrambled by a C-RNTI. In another example, since an RNTI that is mostly used for an NCR-MT is a new RNTI, such as R-RNTI/N-RNTI/NCR-RNTI, the DCI size budget applies with such new RNTI and need not include a C-RNTI. For example, the DCI size budget can be for up to 4 DCI format sizes for NCR-MT, and up to 3 DCI format sizes for DCI formats with CRC scrambled with the new RNTI such as R-RNTI/N-RNTI/NCR-RNTI. In another example, to accommodate a simpler implementation or operation for an NCR, a reduced DCI size budget may be adopted for an NCR-MT. For example, an NCR-MT may not expect to be configured to decode more than 2 or 3 DCI format sizes for PDCCH receptions in an active DL BWP of a serving cell of NCR-MT.

For example, PDCCH monitoring limits for an NCR-MT can be same as those described in TS 38.213 such as with corresponding definitions and procedures. In another example, to accommodate a simplified operation/implementation of NCR-MT, only Rel-15 limits apply as described in TS 38.213. Therefore, an NCR-MT need not support span-based PDCCH monitoring, or PDCCH monitoring from multiple transmission-reception points (multi-TRP or mTPR) and so on.

An NCR-MT can be configured to receive PDCCH providing a DCI format 2_8 with CRC scrambled by NCR-RNTI for beam indication for NCR-Fwd. For example, DCI format 2_8 can also provide an on-off indication or an indication for power control for an NCR-Fwd. For example, DCI format 2_8 can be used for beam/on-off/power-control indication for an NCR-Fwd that operates with multiple bands/passbands/carriers or with multiple antenna panels/arrays. For example, the NCR-MT monitors PDCCH providing a DCI format 2_8 in a dedicated/NCR-specific search space (USS) set.

An NCR-MT can be configured to receive PDCCH providing unicast DCI formats, such as one or more of DCI formats 1_0/1_1/_2, for reception of PDSCHs that provide system information, RRC configuration including for NCR-Fwd periodic beam indication (or on-off/power control indication) or MAC-CE commands for NCR-Fwd semi-persistent beam indication (or on-off/power control indication). An NCR-MT can also be configured to receive PDCCH providing one of more of DCI formats 0_0/0_1/0_2 for transmission of PUSCH/PUCCH, such as for transmission of HARQ-ACK information in response to PDSCH receptions, or for CSI or beam measurement report, or for scheduling request (SR) or link recovery request (LRR), or for MAC-CEs such as for PHR or BSR, or for providing assistance information to a serving cell/gNB.

In one example, a DCI format 2_8 with CRC scrambled with NCR-RNTI can be subject to a predetermined size limit, such as a maximum of 128 bits. In one example, the NCR-MT determines a size of a DCI format 2_8 based on configuration information provided for different fields in the DCI format 2_8. For example, the NCR-MT adjusts a size of DCI format 2_8 in order to achieve a predetermined maximum number of sizes for DCI formats, also referred to as DCI size budget for brevity, that the UE decodes, for example, up to 3 DCI sizes for DCI formats with CRC scrambled by C-RNTI, and up to 4 size for DCI formats with any RNTI.

There are various examples for an NCR-MT to achieve a DCI size budget.

In one example, the NCR-MT does not expect to handle a configuration (for fields of DCI format 2_8) that results in more than 4 DCI sizes across DCI formats with different RNTIs, including DCI format 2_8, or more than 3 DCI sizes for DCI formats with CRC scrambled by C-RNTI. For example, the NCR-RNTI of DCI format 2_8 is considered as a C-RNTI for the purposes of determining the DCI size budget. For example, the NCR-RNTI of DCI format 2_8 is not considered as a C-RNTI for the purposes of determining the DCI size budget. For example, the NCR-MT does not expect to handle a configuration (for fields of DCI format 2_8) that results in a DCI format 2_8 with: (1) a size larger than 128 bits; (2) a size different from all other DCI formats; (3) a size different from DCI formats with CRC scrambled by C-RNTI; or (4) a size different from DCI formats scrambled by RNTIs other than C-RNTI.

For example, a size of a DCI format 2_8 can be aligned (e.g., by applying zero-padding to the end of the DCI format 2_8) with a size of a reference DCI format. For example, a DCI format 2_8 can be size aligned with a size of: (1) a DCI format 2_X (for example, with X from one of {0, 1, . . . , 7} that the NCR-MT monitors and is predetermined in the specifications of system operation or provided by higher layers), when the size of DCI format 2_8 is smaller than the size of DCI format 2_X or]; (2) a DCI format 2_X that has an RRC-configured DCI size (for example, with X from one of {0, 1, 4, 5, 6, 7} that the NCR-MT monitors and is predetermined in the specifications of system operation or provided by higher layers) when the size of DCI format 2_8 is smaller than the size of DCI format 2_X; (3) a DCI format provided by a PDCCH monitored according to a common search space (CSS), such as DCI format 1_0 for PDCCH receptions on the PCell for NCR-MT; (4) a DCI format provided by a PDCCH monitored according to a dedicated search space (USS), such as DCI format 1_1/1_2/1_3 or 0_1/0_2/0_3 (that is predetermined in the specifications of system operation or provided by higher layers); (5) a DCI format with a largest DCI size among DCI formats provided by PDCCHs monitored according to USS); (6) a DCI format with a largest DCI size among DCI formats provided by PDCCHs monitored according to a CSS; or (7) a DCI format with a largest DCI size among DCI formats provided by PDCCHs monitored according to any search space (CSS or USS).

For example, a DCI format 2_8 can be size aligned with a closest-size DCI format. For example, a DCI format 2_8 can be size aligned with a DCI format that has a smallest size among DCI formats that have larger size than DCI format 2_8. For example, a DCI format 2_8 can be size aligned with a second-largest DCI format that the NCR-MT monitors.

For example, a DCI format 2_8 can be size aligned with a DCI format that has a smallest size among DCI formats that have larger size than DCI format 2_8 and are not larger than the predetermined size for DCI format 2_8, such as 128 bits. For example, a DCI format 2_8 can be size aligned with a first reference DCI format when a size of the first reference DCI format is not larger than the predetermined size for DCI format 2_8, such as 128 bits, and can be size aligned with a second reference DCI format when a size of the first reference DCI format is larger than 128 bits and a size of the second DCI format is no longer than 128 bits. For example, a size of DCI format 2_8 is aligned with DCI format 1_1 (or 1_3) when DCI format 1_1/1_3 is a first reference DCI format with size no larger than 128 bits, and a size of DCI format 2_8 is aligned with DCI format 0_1 (or 0_3) when DCI format 1_1/1_3 is larger than 128 bits and DCI format 0_1/0_3 is no larger than 128 bits.

For example, the above size alignment, such as size alignment with a reference DCI format, can apply before or after DCI size alignment for other DCI formats. For example, the NCR-MT first determines DCI sizes for all DCI formats, excluding DCI format 2_8, using DCI size alignment procedures specified in TS 38.212, and then applies one or a combination of above DCI size alignment methods for DCI format 2_8 (such as DCI size matching with a reference DCI format) as previously described. In another example, the NCR-MT first applies one or a combination of above DCI size alignment methods for DCI format 2_8 (such as DCI size matching with a reference DCI format) as previously described, and then applies DCI size alignment procedures specified in TS 38.212 to all DCI formats. For example, when zero padding is applied to a DCI format that is a reference DCI format for DCI format 2_8, the DCI format 2_8 also applies a same number of zero padding.

In another example, a definition of a DCI size budget can be modified for an NCR so that the NCR expects to monitor PDCCH candidates for up to 4 sizes of DCI formats that include up to 3 sizes of DCI formats with CRC scrambled by any NCR-specific RNTI per serving cell. Herein, an NCR -specific RNTI can include C-RNTI and any other RNTI that an NCR uses to monitor a DCI format in a USS set. For example, an NCR-MT expects to monitor PDCCH candidates for up to 4 sizes of DCI formats that include up to 3 sizes of DCI formats with CRC scrambled by C-RNTI or NCR-RNTI per serving cell. For example, an IAB-MT expects to monitor PDCCH candidates for up to 4 sizes of DCI formats that include up to 3 sizes of DCI formats with CRC scrambled by C-RNTI or AI-RNTI per serving cell, at least when the IAB-MT is configured to monitor a DCI format 2_5 for resource availability indicator with CRC scrambled by AI-RNTI in an IAB-specific search space (USS) set.

For example, a DCI size alignment procedure such as that in TS 38.212 (or a forthcoming version in TS 38.212 that may also include the multi-cell scheduling DCI format 0_3/1_3) is updated such that DCI size alignment includes all DCI formats using any RNTI that are provided by PDCCHs monitored in NCR -specific search space (USS) sets. For example, for an NCR-MT, a DCI size alignment procedure includes, in addition to DCI formats 0_0/0_1/0_2/0_3 and 1_0/1_1/1_2/1_3 using C-RNTI for unicast data scheduling, DCI format 2_8 using NCR-RNTI for beam indication, where corresponding PDCCH is also monitored in an NCR-specific search space (USS) set.

For example, a step 4E is added for NCR-MT (after step 4C for size matching DCI format 0_1 with 1_1 in TS 38.212, and a new step 4D for size matching multi-cell scheduling DCI format 0_3 with 1_3 to be added in TS 38.212 such that DCI format 2_8 is size matched with one of: (1) DCI format 0_1/1_1; (2) DCI format 0_3/1_3; or (3) one of DCI formats 0_1/1_1 or 0_3/1_3 that has a larger (or smaller) size.

For example, zeros are appended to the above DCI formats until they have a same size as DCI format 2_8, or zeros are appended to DCI format 2_8 until the format has a same size as the above DCI formats. In another example, the additional step for DCI size matching for DCI format 2_8 is added (e.g., as a step 4C-0) between step 4C in TS 38.212 and the new step 4D to be added in TS 38.212 so that DCI format 2_8 is size matched with DCI formats 0_1/1_1, and before size matching DCI format 0_3/1_3. For example, the additional step for DCI size matching for DCI format 2_8 is added (e.g., as a step 4B-0) between step 4B and 4C in TS 38.212 so that DCI format 2_8 is size matched with DCI formats 0_2/1_2, and before size matching DCI format 0_1/1_1 (and DCI formats 0_3/1_3).

In one example, an NCR can be configured to receive PDCCH for multiple DCI formats with CRC scrambled by NCR-RNTI. For example, above methods can equally apply to the multiple DCI formats. For example, the multiple DCI formats can be size aligned based on the previously described methods, and the multiple DCI formats include a flag (e.g., with 1-2 bits) to indicate each of the multiple DCI formats, such as a first value of the flag corresponding to beam indication, a second value of the flag corresponding to power control indication, a third value of flag corresponding to another NCR functionality, such as on-off indication, multi-band operation, or multi-panel operation, and so on. In another example, the multiple DCI formats can have different sizes, and the previous methods can apply independently to each of the multiple DCI formats. For example, there can be a first reference DCI format for size alignment of a first NCR DCI format, and a second reference DCI format for size alignment of a second NCR DCI format, and so on. For example, the specifications of system operation can include an ordering for the steps when DCI size alignment is applied to each of the multiple DCI formats.

Various methods can be considered for an RNTI that is used for monitoring PDCCH in a USS set that provides a DCI format 2_8 for beam/power/on-off/TDD indication for an NCR.

For a search space set s associated with CORESET p, the CCE indexes for aggregation level L corresponding to PDCCH candidate m_{s,n}_{_{CI}}^{(L)} of the search space set in slot n_{s,f}^{μ} for an active DL BWP of a serving cell corresponding to carrier indicator field value n_{CI}, or cell set indicator n_{CI}, are given by

$$L \cdot \{ ( {Y}_{p , {n}_{s , f}^{μ}} + ⌊ \frac{{m}_{s , {n}_{CI =}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

where, for any CSS, Y_{p,n}_{_{s,f}}^{μ}=0; for a USS, Y_{p,n}_{_{s,f}}^{μ}=(Aₚ·Y_{p,n}_{_{s,f}}^{μ}−1) modD, Y_{p,-1}=n_{RNTI}≠0, Aₚ=39827 for pmod3=0, Aₚ=39829 for pmod3=1, Aₚ=39839 for pmod3=2, and D=65537; i=0, . . . , L−1; N_{CCE,p} is the number of CCEs, numbered from 0 to N_{CCE,p}−1, in CORESET p and, if any, per RB set; n_{CI} is: (1) the carrier indicator field value, if provided by cif-InSchedulingCell in CrossCarrierSchedulingConfig for the serving cell on which PDCCH is monitored, except for scheduling of the serving cell from the same serving cell in which case n_{CI}=0; (2) the cell set indicator value, if provided by nCI-Value in MC-DCI-SetofCells for the serving cell on which PDCCH is monitored; (3) otherwise, including for any CSS, n_{CI}=0, m_{s,n}_{_{CI}}^{(L)}=0, . . . , M_{s,n}_{_{CI}}^{(L)}−1, where M _{s,n}_{_{CI}}^{(L)} is the number of PDCCH candidates the UE is configured to monitor for aggregation level L of a search space set s for a serving cell corresponding to n_{CI} or for a cell set corresponding to n_{CI}; (4) for any CSS, M_{s,max}^{(L)}=M_{s,0}^{(L)}; (5) for a USS, M_{s,max}^{(L)} is the maximum of M_{s,n}_{_{CI}}^{(L)} over all configured n_{CI} values for a CCE aggregation level L of search space set s; and (6) the RNTI value used for n_{RNTI} is: (i) the C-RNTI when DCI formats provided by dci-Formats or dci-FormatsExt or dci-FormatsMC include one or more of DCI formats 0_0, 0_1, 0_2, 0_3, 1_0, 1_1, 1_2,1_3; (ii) the SL-RNTI or SL-CS-RNTI or V-RNTI when DCI formats provided by dci-FormatsSL include DCI formats 3_0 or 3_1; (iii) the AI-RNTI when DCI formats provided by dci-Formats-MT include DCI format 2_5; or (iv) the NCR-RNTI when DCI formats provided by dci-FormatNCR include DCI format 2_8.

In one embodiment, for an NCR-MT with capability to receive dedicated signaling such as MAC-CE for determination of backhaul link (BH-link) beam, the MAC-CE provides a TCI state or SRI associated with the active BWP of the control link (C-link). When an active BWP of the C-link is switched, for example via a DCI format or an associated timer, the NCR-Fwd can continue to apply the same beam of the old BWP for the BH-link, or can apply a beam from the new BWP of the C-link with a same beam index as in the old BWP, or can apply a predetermined/default beam based on the PDCCH/PUCCH configuration of the new BWP of the C-link or can be set to OFF state. The NCR can apply one of these methods until the NCR-MT receives a new MAC-CE providing a new TCI state or SRI associated with the new BWP of the C-link.

A spatial domain filter (beam) for BH link of NCR-Fwd can be from a list of spatial domain filters (beams) for C-link of NCR-MT. A spatial domain filter for the BH beam of NCR-Fwd can be same as a spatial domain filter of the C-link of NCR-MT, or depending on NCR capability, an NCR determines a spatial domain transmission filter for the BH link based on dedicated signal via MAC-CE or based on predetermined rules.

When the NCR simultaneously receives via both the control link and the backhaul link in a set of symbols, a TCI state for receptions on the backhaul link is same as a TCI state for receptions on the control link in the set of symbols. When the NCR simultaneously transmits via both the control link and the backhaul link in a set of symbols, a spatial filter for transmissions on the backhaul link is same as a spatial filter for transmissions on the control link in the set of symbols.

When the NCR does not simultaneously receive on the control link and the backhaul link: (1) if the NCR does not support determination of a TCI state for receptions on the backhaul link based on an indication of a TCI state by the serving cell, or if the NCR does not receive an indication of a TCI state, for receptions on the backhaul link in TS 38.321; (i) if the NCR does not receive an indication of a unified TCI state for receptions by the NCR-MT, receptions on the backhaul link use same QCL parameters as the ones for PDCCH receptions in a CORESET with the lowest controlResourceSetId; (ii) else, receptions on the backhaul link use the QCL parameters provided by an indicated unified TCI state for receptions by the NCR-MT; (2) else receptions on the backhaul link use QCL parameters provided by a TCI state in a MAC CE in TS 38.321.

When the NCR does not simultaneously transmit on the control link and the backhaul link: (1) if the NCR does not support determination of a spatial filter for transmissions on the backhaul link based on an indication of a unified TCI state or SRI by the serving cell, or if the NCR-MT does not receive an indication of a unified TCI state or SRI for determining a spatial filter, for transmissions on the backhaul link: (i) if the NCR does not receive an indication of a unified TCI state for transmissions by the NCR-MT, transmissions on the backhaul link use a same spatial filter as the one associated with the PUCCH resource with the smallest pucch-ResourceId in PUCCH-ResourceSet; and (ii) else, transmissions on the backhaul link use a spatial filter corresponding to an indicated unified TCI state for transmissions by the NCR-MT; and (2) else transmissions on the backhaul link use a spatial filter corresponding to a unified TCI state or SRI provided by a MAC CE in TS 38.321.

In one example, a TCI state or unified TCI state or SRI provided by a MAC-CE for indication of spatial filter (beam) for DL reception or for UL transmission on the BH-link is based on a list of DL/Joint/UL TCI states or SRIs (for corresponding SRS resources) in active DL or UL BWP of C-link.

In one example, for an NCR with corresponding capability, when an NCR receives/applies a first MAC-CE that indicates a first TCI state or unified TCI state or SRI for DL reception or for UL transmission on the BH-link in a first slot, and determines a BWP switching for the C-link in a second slot (that is after the first slot), the following can apply for the BH-link spatial filter (beam) after the second slot.

In one example, the NCR continues to use a first spatial filter for the BH-link that is associated with the first TCI state or unified TCI state or SRI after the second slot (i.e., after BWP switching on the BH-link); for example, the NCR continues to use the first spatial filter for the BH-link until the NCR receives/applies a second MAC-CE that indicates a second TCI state or a unified TCI state or a SRI corresponding to the new BWP of the C-link;

In another example, starting from the second slot (or a first/earliest slot after the second slot or a predetermined/configured/indicated number of slots after the second slot), the NCR uses a second spatial filter for the BH-link that corresponds to a second TCI state or a unified TCI state or a SRI from a list of DL/Joint/UL TCI states or SRIs (for corresponding SRS resources) in the new DL or UL BWP of C-link, wherein the second TCI state or unified TCI state or SRI has a same index as the respective first TCI state or unified TCI state or SRI (so the index can be the same, while the corresponding list can be different for the old/new TCI state or unified TCI state or SRI, so the corresponding first and second TCI states or unified TCI states or SRIs can be different); for example, the NCR uses the second spatial filter for the BH-link until the NCR receives/applies a second MAC-CE that indicates a third TCI state or unified TCI state or SRI corresponding to the new BWP of the C-link;

In yet another example, starting from the second slot (or a first/earliest slot after the second slot or a predetermined/configured/indicated number of slots after the second slot), the NCR uses a second spatial filter for the BH-link that corresponds to a predetermined spatial filter for the new BWP of the cell for NCR-MT.

In one example, if the NCR does not receive an indication of a unified TCI state for receptions by the NCR-MT on/for the new DL BWP (or on a DL BWP on same or different cell of NCR-MT that provides unified TCI states for the new BWP of the cell such as a BWP/cell indicated by via ServingCellAndBWP-Id value in unifiedTCI-StateRef in dl-OrJointTCI-StateList), receptions on the backhaul link use same QCL parameters as the ones for PDCCH receptions in a CORESET with the lowest controlResourceSetId in the new DL BWP (or ones for PDCCH receptions in a CORESET with the lowest controlResourceSetId in an active DL BWP of a corresponding scheduling cell); else, receptions on the backhaul link use the QCL parameters provided by an indicated unified TCI state for receptions by the NCR-MT on the new DL BWP of the cell.

In another example, if the NCR does not receive an indication of a unified TCI state for transmissions by the NCR-MT on the new DL BWP (or on a DL BWP on same or different cell of NCR-MT that provides unified TCI states for the new BWP of the cell such as a BWP/cell indicated by via ServingCellAndBWP-Id value in untfiedTCI-StateRef in dl-OrJointTCI-StateList or in ul-TCI-StateList or in srs-DLorJointTCI-State), transmissions on the backhaul link use a same spatial filter as the one associated with the PUCCH resource with the smallest pucch-Resourceld in PUCCH-ResourceSet in the new UL BWP (or associated with the PUCCH resource with the smallest pucch-Resourceld in PUCCH-ResourceSet in an active UL BWP of a PUCCH cell associated with the cell); else, transmissions on the backhaul link use a spatial filter corresponding to an indicated unified TCI state for transmissions by the NCR-MT on the new BWP of the cell.

For example, the NCR uses the second spatial filter for the BH-link (based on the predetermined beam in the new BWP) until the NCR receives/applies a second MAC-CE that indicates a third TCI state or unified TCI state or SRI corresponding to the new BWP of the C-link.

In another example, the NCR uses a predetermined/default spatial filter corresponding to the old active BWP (for example, the first BWP), for example, based on a PDCCH/CORESET spatial filter or a PUCCH spatial filter as described earlier, corresponding to the old active BWP. For example, the NCR applies such spatial filter until the NCR receives/applies a second MAC-CE that indicates a new TCI state or unified TCI state or SRI corresponding to the new BWP of the C-link.

In another example, the NCR is predetermined or indicated to go to the OFF state (or not forwarding) when an active BWP of the C-link of NCR-MT is switched (from a first BWP or a second BWP). For example, the NCR is set to the OFF state until the NCR receives new dedicated signaling such as a new MAC-CE for BH beam indication corresponding to the new active BWP (for example, the second BWP).

For example, above methods can be applied starting from the second slot (slot for the BWP switching) or starting from the first/earliest slot after the second slot, or starting from N symbols or slots after the second slot, wherein N is predetermined in the specifications of system operations or configured by higher layers such as RRC or indicated by L1/L2 signaling such as a MAC-CE or a DCI format. For example, a symbol or slot can be a slot in the subcarrier spacing (SCS) of the first/old BWP or the second/new BWP or in the smaller/larger SCS between the new BWP and old BWP, or in the smallest/largest SCS among the configured BWPs, or in a predetermined SCS such as 15 kHz, or in an SCS that is based on a frequency range, such as 15 kHz for FR1 and 60 kHz for FR2, or in a configured or indicated SCS, or in an SCS for the corresponding resource or resource set or list of resources/resource sets for the access link, or in the smallest/largest SCS among such resources/resource sets.

In one example, an NCR behavior for BH beam determination after BWP change can be predetermined in the specifications of the system operation, or can be configured by higher layers, or can be indicated by L1/L2 signaling, such as by a MAC-CE or a DCI formats. For example, when a BWP switching for the C-link of NCR-MT is based on an BWP field of a DCI format, the DCI format can include additional values for the BWP field (for example, when a length of the BWP field is increased to accommodate indication of additional values/information) or the DCI format can include new/additional fields for indication of the method to apply for BH beam determination after BWP switching of the C-link. For example, a first value of such field (such as a 0 or 00) can indicate using the predetermined beam based on the new BWP of the C-link, or a second value such as 1 or 01 can indicate re-using the BH beam of the old BWP, or a third value such as 10 can indicate using a beam in the new BWP with same beam index as the BH beam corresponding to the old BWP of the C-link, or a fourth value such as 11 can indicate switching OFF the NCR-Fwd.

Above methods are described in terms of spatial filter determination for the BH link after BWP switching on the C-link when the BH beam is provided by a dedicated signaling such as a MAC-CE for BH beam determination. Similar methods can be applied for determination of spatial domain filter of the BH beam when the BH beam is determined based on predetermined rule, such reusing a certain spatial filter of PDCCH or CORESET or a certain PUCCH spatial filter as described above. For example, the spatial filter of the BH link can be based on corresponding configuration for PDCCH or CORESET or PUCCH of the new active BWP or the NCR may be set to the OFF state.

The present disclosure can be applicable to NR specifications Rel-18 and beyond to provide interference management via on-off indication for various repeater/relay nodes, including SR, also known as NCR, IAB nodes, or RIS nodes.

The embodiments are generic and can also apply to various frequency bands in different frequency ranges (FR) such as FR1, FR2, FR3, and FR2-2, e.g., low frequency bands such as below 1 GHz, mid frequency bands, such as 1-7 GHz, and high/millimeter frequency bands, such as 24-100 GHz and beyond. In addition, the embodiments are generic and can apply to various use cases and settings as well, such as single-panel UEs and multi-panel UEs, eMBB, URLLC and IIoT, mMTC and IoT, sidelink/V2X, operation with multi-TRP/beam/panel, operation in NR-U, NTN, aerial systems such as drones, operation with RedCap UEs, private or NPN, and so on.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for a network-controlled repeater (NCR), the method comprising:
receiving first information, by an NCR mobile termination (NCR-MT) entity, for time-domain resources and for corresponding beams for an access link of an NCR-forwarding (NCR-Fwd) entity;
receiving or transmitting, by the NCR-Fwd entity, radio frequency (RF) signals on the access link using the beams over the corresponding time-domain resources prior to a link failure event;
determining, by the NCR-MT entity, the link failure event on a control link (C-link) of the NCR-MT entity;
performing, by the NCR-MT entity, a link recovery procedure on the C-link; and
suspending receiving or transmitting, by the NCR-Fwd entity, the RF signals on the access link using the beams over the corresponding time-domain resources during the link recovery procedure.

2. The method of claim 1, further comprising:
resuming receiving or transmitting, by the NCR-Fwd entity, the RF signals on the access link using the beams over the corresponding time-domain resources after successful completion of the link recovery procedure.

3. The method of claim 1, further comprising:
determining, by the NCR-MT entity:
a first spatial filter for a backhaul link of the NCR-Fwd entity prior to the link failure event, and
a second spatial filter for the backhaul link of the NCR-Fwd entity after successful completion of the link recovery procedure, wherein the second spatial filter is determined based on the link recovery procedure; and
receiving or transmitting, by the NCR-Fwd entity, the RF signals on backhaul link using:
the first spatial filter prior to the link failure event, and
the second spatial filter after the successful completion of the link recovery procedure.

4. The method of claim 1,wherein:
determining the link failure event on the C-link of the NCR-MT entity further comprises determining, by the NCR-MT entity, a radio link failure (RLF) event for the C-link of the NCR-MT entity,
performing the link recovery procedure on the C-link further comprises performing, by the NCR-MT entity, a radio resource control (RRC) re-establishment procedure for the C-link, and
suspending receiving or transmitting the RF signals on the access link using the beams over the corresponding time-domain resources during the link recovery procedure further comprises suspending receiving or transmitting, by the NCR-Fwd entity, the RF signals on the access link using the beams over the corresponding time-domain resources during the RRC re-establishment procedure.

5. The method of claim 4, wherein the time-domain resources are first time-domain resources and the beams are first beams, the method further comprising:
receiving second information, by the NCR-MT entity, for second time-domain resources and for corresponding second beams for the access link of the NCR-Fwd entity, wherein the reception of the second information is after successful completion of the RRC re-establishment procedure;
discarding the first information, by the NCR-MT entity; and
resuming receiving or transmitting, by the NCR-Fwd entity, the RF signals on the access link using the second beams over the corresponding second time-domain resources after reception of the second information.

6. The method of claim 1, further comprising:
determining, by the NCR-MT entity, a change of a radio resource control (RRC) state of the NCR-MT entity from a first RRC state to a second RRC state; and
continuing to receive or transmit, by the NCR-Fwd entity, the RF signals on the access link using the beams over the corresponding time-domain resources when the first RRC state is RRC CONNECTED and the second RRC state is RRC INACTIVE, or
suspending receiving or transmitting, by the NCR-Fwd entity, the RF signals on the access link when the first RRC state is RRC CONNECTED or RRC INACTIVE and the second RRC state is RRC IDLE.

7. The method of claim 1, further comprising:
identifying, by the NCR-MT entity, a first spatial filter for a backhaul link of the NCR-Fwd entity for transmitting or receiving the RF signals in the time-domain resources, wherein the first spatial filter corresponds to a first bandwidth part (BWP) of the C-link;
determining, by the NCR-MT entity:
a change of an active BWP of the C-link from the first BWP to a second BWP, and
a second spatial filter for the backhaul link of the NCR-Fwd entity for transmitting or receiving the RF signals in the time-domain resources, wherein the second spatial filter is one of:
the first spatial filter,
a spatial filter that has a same index as an index of the first spatial filter and corresponds to the second BWP, or
a predetermined spatial filter, associated with a physical channel, that corresponds to the second BWP.

8. A network-controlled repeater (NCR) comprising:
a transceiver for an NCR mobile termination (NCR-MT) entity configured to receive first information for time-domain resources and for corresponding beams for an access link of an NCR-forwarding (NCR-Fwd) entity;
a transceiver for the NCR-Fwd entity, operably coupled to the transceiver for the NCR-MT entity, configured to receive or transmit radio frequency (RF) signals on the access link using the beams over the corresponding time-domain resources prior to a link failure event; and
a processor for the NCR-MT entity, operably coupled to the transceiver for the NCR-MT entity and the transceiver for the NCR-Fwd entity, configured to:
determine the link failure event on a control link (C-link) of the NCR-MT entity, and
perform a link recovery procedure on the C-link,
wherein the transceiver for the NCR-Fwd entity is further configured to suspend receiving or transmitting the RF signals on the access link using the beams over the corresponding time-domain resources during the link recovery procedure.

9. The NCR of claim 8, wherein the transceiver for the NCR-Fwd entity is further configured to resume receiving or transmitting the RF signals on the access link using the beams over the corresponding time-domain resources after successful completion of the link recovery procedure.

10. The NCR of claim 8, wherein:
the processor of the NCR-MT entity is further configured to determine:
a first spatial filter for a backhaul link of the NCR-Fwd entity prior to the link failure event, and
a second spatial filter for the backhaul link of the NCR-Fwd entity after successful completion of the link recovery procedure,
the second spatial filter is determined based on the link recovery procedure, and
the transceiver of the NCR-Fwd entity is further configured to transmit or receive the RF signals on the backhaul link using:
the first spatial filter prior to the link failure event, and
the second spatial filter after the successful completion of the link recovery procedure.

11. The NCR of claim 8, wherein:
to determine the link failure event on the C-link of the NCR-MT entity, the processor of the NCR-MT entity is further configured to determine a radio link failure (RLF) event for the C-link of the NCR-MT entity,
to perform the link recovery procedure on the C-link, the processor of the NCR-MT entity is further configured to perform a radio resource control (RRC) re-establishment procedure for the C-link; and
to suspend receiving or transmitting the RF signals on the access link using the beams over the corresponding time-domain resources during the link recovery procedure, the transceiver of the NCR-Fwd entity is further configured to suspend receiving or transmitting the RF signals on the access link using the beams over the corresponding time-domain resources during the RRC re-establishment procedure.

12. The NCR of claim 11, wherein:
the time-domain resources are first time-domain resources and the beams are first beams;
the transceiver of the NCR-MT entity is further configured to receive second information for second time-domain resources and for corresponding second beams for the access link of the NCR-Fwd entity, wherein the reception of the second information is after successful completion of the RRC re-establishment procedure;
the processor of the NCR-MT entity is further configured to discard the first information, by the NCR-MT entity; and
the transceiver of the NCR-Fwd entity is further configured to resume receiving or transmitting the RF signals on the access link using the second beams over the corresponding second time-domain resources after reception of the second information.

13. The NCR of claim 8, wherein:
the processor of the NCR-MT entity is further configured to determine a change of a radio resource control (RRC) state of the NCR-MT entity from a first RRC state to a second RRC state; and
the transceiver of the NCR-Fwd entity is further configured to:
continue to receive or transmit the RF signals on the access link using the beams over the corresponding time-domain resources when the first RRC state is RRC CONNECTED and the second RRC state is RRC INACTIVE, or
suspend receiving or transmitting the RF signals on the access link when the first RRC state is RRC CONNECTED or RRC INACTIVE and the second RRC state is RRC IDLE.

14. The NCR of claim 8, wherein:
the processor of the NCR-MT entity is further configured to:
identify a first spatial filter for a backhaul link of the NCR-Fwd entity for transmitting or receiving the RF signals in the time-domain resources, wherein the first spatial filter corresponds to a first bandwidth part (BWP) of the C-link; and
determine:
a change of an active BWP of the C-link from the first BWP to a second BWP, and
a second spatial filter for the backhaul link of the NCR-Fwd entity for transmitting or receiving the RF signals in the time-domain resources, wherein the second spatial filter is one of:
the first spatial filter,
a spatial filter that has a same index as an index of the first spatial filter and corresponds to the second BWP, or
a predetermined spatial filter, associated with a physical channel, that corresponds to the second BWP.

15. A base station comprising:
a transceiver configured to:
transmit, to a network-controlled repeater mobile termination (NCR-MT) entity, first information for time-domain resources and for corresponding beams for an access link of a network-controlled repeater forwarding (NCR-Fwd) entity, and
transmit to or receive from the NCR-Fwd entity radio frequency (RF) signals on a backhaul link of the NCR-Fwd entity associated with transmissions or receptions of RF signals on the access link using the beams over the corresponding time-domain resources prior to a link failure event; and
a processor, operably coupled to the transceiver, configured to:
determine a link failure event on a control link (C-link) of the NCR-MT entity, and
perform a link recovery procedure on the C-link,
wherein the transceiver is further configured to:
suspend transmitting or receiving the RF signals on the backhaul link associated with transmissions or receptions of the RF signals on the access link using the beams over the corresponding time-domain resources during a link recovery procedure associated with the link failure event.

16. The base station of claim 15, wherein the transceiver is further configured to resume transmitting or receiving the RF signals on the backhaul link associated with transmissions or receptions of the RF signals on the access link using the beams over the corresponding time-domain resources after successful completion of the link recovery procedure.

17. The base station of claim 15, wherein:
the processor is further configured to determine:
a first spatial filter for a backhaul link of the NCR-Fwd entity prior to the link failure event, and
a second spatial filter for the backhaul link of the NCR-Fwd entity after the successful completion of the link recovery procedure, wherein:
the second spatial filter is determined based on the link recovery procedure, and
the transceiver is further configured to transmit or receive the RF signals to or from the NCR-Fwd entity on the backhaul link using:
the first spatial filter prior to the link failure event, and
the second spatial filter after the successful completion of the link recovery procedure.

18. The base station of claim 15, wherein:
to determine the link failure event on the C-link of the NCR-MT entity, the processor is further configured to determine a radio link failure (RLF) event for the C-link of the NCR-MT entity,
to perform the link recovery procedure on the C-link, the processor is further configured to perform a radio resource control (RRC) re-establishment procedure for the C-link; and
to suspend transmitting or receiving the RF signals on the backhaul link associated with transmissions or receptions of the RF signals on the access link using the beams over the corresponding time-domain resources during a link recovery procedure associated with the link failure event, the transceiver is further configured to suspend transmitting or receiving the RF signals on the backhaul link associated with transmissions or receptions of the RF signals on the access link using the beams over the corresponding time-domain resources during the RRC re-establishment procedure.

19. The base station of claim 18, wherein:
the time-domain resources are first time-domain resources and the beams are first beams;
the transceiver is further configured to transmit, to the NCR-MT entity, second information for second time-domain resources and for corresponding second beams for the access link of the NCR-Fwd entity, wherein the reception of the second information is after successful completion of the RRC re-establishment procedure; and
the transceiver is further configured to resume receiving or transmitting the RF signals on the backhaul link associated with transmissions or receptions of the RF signals on the access link using the second beams over the corresponding second time-domain resources after reception of the second information.

20. The base station of claim 15, wherein:
the processor is further configured to determine a change of a radio resource control (RRC) state of the NCR-MT entity from a first RRC state to a second RRC state; and
the transceiver is further configured to:
continue to transmit or receive the backhaul RF signals on the backhaul link associated with transmissions or receptions of the RF signals on the access link using the beams over the corresponding time-domain resources when the first RRC state is RRC CONNECTED and the second RRC state is RRC INACTIVE, or
suspend transmitting or receiving the backhaul RF signals on the backhaul link associated with transmissions or receptions of the RF signals on the access link when the first RRC state is RRC CONNECTED or RRC INACTIVE and the second RRC state is RRC IDLE.
